(19) United States
(12) Patent Application Publication
(10) Pub. No.: US 2019/0230556 A1
(43) Pub. Date: Jul. 25, 2019

(54) APPARATUS AND METHOD FOR NETWORK FUNCTION PROFILE MANAGEMENT

(71) Applicant: Electronics and Telecommunications Research Institute, Daejeon (KR)

(72) Inventor: Seung-Ik LEE, Daejeon (KR)

(73) Assignee: Electronics and Telecommunications Research Institute, Daejeon (KR)

(21) Appl. No.: 16/250,103

(22) Filed: Jan. 17, 2019

(30) Foreign Application Priority Data
Jan. 19, 2018 (KR) 10-2018-0007338
Dec. 27, 2018 (KR) 10-2018-0170475

(51) Int. Cl. H04W 28/16; H04W 16/02

(52) U.S. Cl. CPC H04W 28/16; H04W 16/02

(57) ABSTRACT

Provided is a method of managing a network function (NF) profile, the method including receiving, by a network function repository function (NRF), a registration request from a management system in response to deploying of an NF instance; adding, the NRF, an NF profile of the new NF instance in response to the registration request; and sending, by the NRF, a registration response to the management system.

### CROSS-REFERENCE TO RELATED APPLICATION(S)

This application claims the priority benefit of Korean Patent Application No. 10-2018-0007338 filed on Jan. 19, 2018 and Korean Patent Application No. 10-2018-0170475 filed on Dec. 27, 2018 in the Korean Intellectual Property Office, the disclosures of which are incorporated herein by reference for all purposes.

### BACKGROUND

### 1. Field

One or more example embodiments relate to a method and apparatus for managing a network function (NF) profile, and more particularly, to register/update/deregister of an NF profile.

### 2. Description of Related Art

In a 5G mobile communication network, a variety of services may be provided to user equipment (UE) through a 5G network technique. To this end, 5G network technology is designed in an end-to-end (E2E) fused network structure to support various devices and various services. In detail, 5G network technology relates to an E2E system in which all of targets, for example, techniques, domains, layers, equipment/devices, and user interactions, of a network connected using various types of methods including a wired manner are fused.

### SUMMARY

At least one example embodiment provides a method and apparatus for managing a network function (NF) profile according to register/update/deregister of the NF profile.

At least one example embodiment also provides a method and apparatus for managing an NF profile that may provide a flexible core network structure through introducing network virtualization technology and may achieve the enhancement in efficiency and cost saving according to managing of a network system and resources.

According to an aspect of at least one example embodiment, there is provided a method of managing an NF profile, the method including receiving, by a network function repository function (NRF), a registration request from a management system in response to deploying of a new NF instance; adding, by the NRF, an NF profile of the new NF instance in response to the registration request; and sending, by the NRF, a registration response to the management system.

The NRF may include NF instance information, and the NF profile of the NF instance may be maintained to an up-to-date state.

The NF profile may include at least one of an NF instance ID, an NF type, a fully qualified domain name (FQDN) or an Internet protocol (IP) address of an NF, a public land mobile network (PLMN) ID, a network slice related identifier, NF capacity information, NF specific service authorization information, identification of stored information, names of supported services, and endpoint information of instance of each supported service.

The network slice related identifier may include network slice selection assistance information (NSSAI), single-network slice selection assistance information (S-NSSAI), and network slice instance (NSI) ID.

According to an aspect of at least one example embodiment, there is provided a method of managing an NF profile, the method including receiving, by an NRF, an update request from a management system in response to a change of an NF profile of an NF instance; updating, by the NRF, the NF profile of the NF instance in response to the update request; and sending, by the NRF, an update response to the management system.

The NRF may include NF instance information (or profile), and the NF profile of the NF instance may be maintained to an up-to-date state.

The NF profile may include at least one of an NF instance ID, an NF type, an FQDN or an IP address of an NF, a PLMN ID, a network slice related identifier, NF capacity information, NF specific service authorization information, identification of stored information, names of supported services, and endpoint information of instance of each supported service.

The network slice related identifier may include NSSAI, S-NSSAI, and NSI ID.

According to an aspect of at least one example embodiment, there is provided a method of managing an NF profile, the method including receiving, by an NRF, a deregistration request from a management system in response to removal of an NF instance; deleting, by the NRF, an NF profile of the NF instance in response to the deregistration request; and sending, by the NRF, a deregistration response to the management system.

The NRF may include NF instance information, and the NF profile of the NF instance may be maintained to an up-to-date state.

The NF profile may include at least one of an NF instance ID, an NF type, an FQDN or an IP address of an NF, a PLMN ID, a network slice related identifier, NF capacity information, NF specific service authorization information, identification of stored information, names of supported services, and endpoint information of instance of each supported service.

The network slice related identifier may include NSSAI, S-NSSAI, and NSI ID.

According to an aspect of at least one example embodiment, there is provided a communication apparatus including an NF profile, the communication apparatus including a processor; and a memory configured to store a computer-readable instruction. When the instruction is executed by the processor, the processor is configured to perform a method of managing the NF profile including receiving, by an NRF, a registration request from a management system in response to deploying of a new NF instance; adding, by the NRF, an NF profile of the new NF instance in response to the registration request; and sending, by the NRF, a registration response to the management system.

The NRF may include NF instance information, and the NF profile of the NF instance may be maintained to an up-to-date state.

The NF profile may include at least one of an NF instance ID, an NF type, an FQDN or an IP address of an NF, a PLMN ID, a network slice related identifier, NF capacity information, NF specific service authorization information, identification of stored information, names of supported services, and endpoint information of instance of each supported service.

The network slice related identifier may include NSSAI, S-NSSAI, and NSI ID.

According to an aspect of at least one example embodiment, there is provided a communication apparatus for managing an NF profile, the communication apparatus including a processor; and a memory configured to store a computer-readable instruction. When the instruction is executed by the processor, the processor is configured to perform a method of managing the NF profile including receiving, by an NRF, an update request from a management system in response to a change of an NF profile of an NF instance; updating, by the NRF, the NF profile of the NF instance in response to the update request; and sending, by the NRF, an update response to the management system.

The NRF may include NF instance information, and the NF profile of the NF instance may be maintained to an up-to-date state.

The NF profile may include at least one of an NF instance ID, an NF type, an FQDN or an IP address of an NF, a PLMN ID, a network slice related identifier, NF capacity information, NF specific service authorization information, identification of stored information, names of supported services, and endpoint information of instance of each supported service.

The network slice related identifier may include NSSAI, S-NSSAI, and NSI ID.

According to an aspect of at least one example embodiment, there is provided a communication apparatus for managing an NF profile, the communication apparatus including a processor; and a memory configured to store a computer-readable instruction. When the instruction is executed by the processor, the processor is configured to perform a method of managing the NF profile including receiving, by an NRF, a deregistration request from a management system in response to removal of an NF instance; deleting, by the NRF, an NF profile of the NF instance in response to the deregistration request; and sending, by the NRF, a deregistration response to the management system.

The NRF may include NF instance information, and the NF profile of the NF instance may be maintained to an up-to-date state.

The NF profile may include at least one of an NF instance ID, an NF type, an FQDN or an IP address of an NF, a PLMN ID, a network slice related identifier, NF capacity information, NF specific service authorization information, identification of stored information, names of supported services, and endpoint information of instance of each supported service.

The network slice related identifier may include NSSAI, S-NSSAI, and NSI ID.

According to example embodiments, there may be provided a method and apparatus for managing an NF profile according to register/update/deregister of the NF profile.

Also, according to example embodiments, there may be provided a method and apparatus for managing an NF profile that may provide a flexible core network structure through introducing network virtualization technology and may achieve the enhancement in efficiency and cost saving according to managing of a network system and resources.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a registration management (RM) state model of a user equipment (UE) according to an example embodiment;

FIG. 2 illustrates an example of a connection management (CM) state transition in a UE according to an example embodiment;

FIG. 3 illustrates an example of a UE registration procedure in a communication system according to an example embodiment;

FIG. 4 illustrates a reference architecture for network slicing according to an example embodiment;

FIG. 5 illustrates an architecture of a network slice according to an example embodiment;

FIG. 6 illustrates an example of a network slice instance and a service instance according to an example embodiment;

FIG. 7 illustrates an example of a service instance according to an example embodiment;

FIG. 8 illustrates an example of selecting a network slice instance in a user equipment registration procedure according to an example embodiment;

FIG. 9 illustrates an example of selecting a network slice instance and a network function instance in a protocol data unit (PDU) session establishment procedure according to an example embodiment;

FIG. 10 illustrates an example of a repository according to an example embodiment;

FIG. 11 illustrates an example of a network function repository function (NRF) configured to perform a network function instance (NFI) selection/discovery function according to an example embodiment;

FIG. 12 illustrates an example of an NF discovery service according to an example embodiment;

FIG. 13 illustrates an example of an NF discovery service through PLMSs according to an example embodiment;

FIG. 14 illustrates an example of an NF service registration procedure according to an example embodiment;

FIG. 15 illustrates an example of an NF service update procedure according to an example embodiment;

FIG. 16 illustrates an example of an NF service deregistration procedure according to an example embodiment;

FIG. 17 illustrates an example of an NF/NF service discovery in the same PLMN according to an example embodiment;

FIG. 18 illustrates an example of an NF/NF service discovery through PLMNs according to an example embodiment; and

FIG. 19 illustrates an example of an NF profile management interface according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component. On the contrary, it should be noted that if it is described that one component is “directly connected,” “directly coupled,” or “directly joined” to another component, a third component may be absent. Expressions describing a relationship between components, for example, “between,” directly between,” or “directly neighboring,” etc., should be interpreted to be alike.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the example embodiments are described with reference to the accompanying drawings.

Terms used or available herein according to example embodiments may follow as:

5G access network: An access network including a 5G-RAN and/or non-3GPP AN connecting to a 5G core network

5G core network: A core network that may connect to a 5G access network.

5G QoS flow: The finest granularity for QoS forwarding treatment in a 5G system. All traffic mapped to the same 5G QoS flow may receive the same forwarding treatment (e.g., scheduling policy, queue management policy, rate shaping policy, and RLC configuration). Providing different QoS forwarding treatment may require separate 5G QoS flow.

5G QoS identifier (5QI): A scalar that is used as a reference to a specific QoS forwarding behavior (e.g., packet loss rate, packet delay budget) to be provided to the 5G QoS flow. This may be implemented in the access network by the 5QI referencing node specific parameters that control the QoS forwarding treatment (e.g., scheduling weights, admission thresholds, queue management thresholds, link layer protocol configuration.).

5G-RAN: A radio access network that supports one or more of the following options with common characteristics that the 5G-RAN connects to 5GS:

1) Standalone new radio

2) New radio may be an anchor with E-UTRA extensions.

3) Standalone E-UTRA

4) E-UTRA may be an anchor with new radio extensions.

5G system: 3GPP system including 5G access network (AN), 5G core network, and UE

Allowed NSSAI: NSSAI provided by a serving PLMN during, for example, a registration procedure, indicating allowed NSSAI by the network for the UE in the serving PLMN for a current registration area.

Allowed area: An area where the UE is allowed to initiate communication.

Configured NSSAI: NSSAI provisioned in the UE per PLMN.

Forbidden area: An area where the UE is not allowed to initiate communication.

Initial registration: UE registration in an RM-DEREGISTERED state.

Mobility pattern: Network concept of determining within the NF the UE mobility parameters.

Mobility registration update: UE re-registration when entering new TA outside a TAI list.

Network function: 3GPP adopted or 3GPP defined processing function in a network, which has defined functional behavior and 3GPP defined interfaces.

Non-allowed area: An area where the UE is allowed to initiate the registration procedure but no other communication.

PDU connectivity service: A service that provides exchange of PDUs between the UE and a data network.

PDU session: Association between the UE and a data network that provides a PDU connectivity service. A type of the PDU session may be an IP, Ethernet, or unstructured.

Periodic registration update: UE re-registration at expiry of a periodic registration timer.

Requested NSSAI: NSSAI provided by the UE to the network.

Service Continuity: Uninterrupted user experience of a service, including cases in which an IP address and/or anchoring point changes.

Session continuity: The continuity of a PDU session. For a PDU session of IP type “session continuity” implies that the IP address is preserved for the lifetime of the PDU session.

Non-seamless non-3GPP offload: The offload of user plane traffic through non-3GPP access without traversing either N3IWF or a UPF device.

<Abbreviations>

5GC: core network

5QI: 5G QoS Indicator

AF: Application Function

5GS: 5G system

5G-AN: 5G access network

5G-GUTI: 5G globally unique temporary identifier

AMF: access and mobility management function

CP: control plane

DC: dual connectivity

DL: downlink

DN: data network

DNN: data network name

HR: home routed (roaming)

LADN: local area data network

MICO: mobile initiated connection only

NF: network function

NR: new radio

NEF: network exposure function

NRF: network function repository function

NSaaS: Network Slice as a Service

NSaaSC: Network Slice as a Service Customer

NSaaSP: Network Slice as a Service Provider

NSC: Network Slice Customer

NSI: Network Slice Instance

NSP: Network Slice Provider

OTT: Over The Top

PCF: policy control function

(R)AN: (radio) access network

SSC: session and service Continuity

UDM: Unified Data Management

UL: uplink

UPF: user plane function

<Registration Management>

The registration management is used to register or deregister a UE/user with a network, and to establish a user context in the network.

The UE/user needs to register with the network to receive a service that requires registration. Once registered and if applicable, the UE updates its registration with the network 1) periodically to remain reachable (period registration update); 2) upon mobility (mobility registration update); or 3) to update its capability or re-negotiate protocol parameters.

An initial registration procedure includes execution of network access control functions (i.e., user authentication and access authorization based on subscription files in UDM). As a result of the registration procedure, an identifier of a serving AMF device serving the UE in an access through which the UE is registered may be registered in the UDM.

The registration management procedure may be applied over a 3GPP access and a non-3GPP access. 3GPP and non-3GPP registration management (RM) states are mutually independent.

The following two RM states are used in the UE and the AMF device that reflect a registration status of the UE in the selected PLMN: 1) RM-DEREGISTERED and 2) RM-REGISTERED.

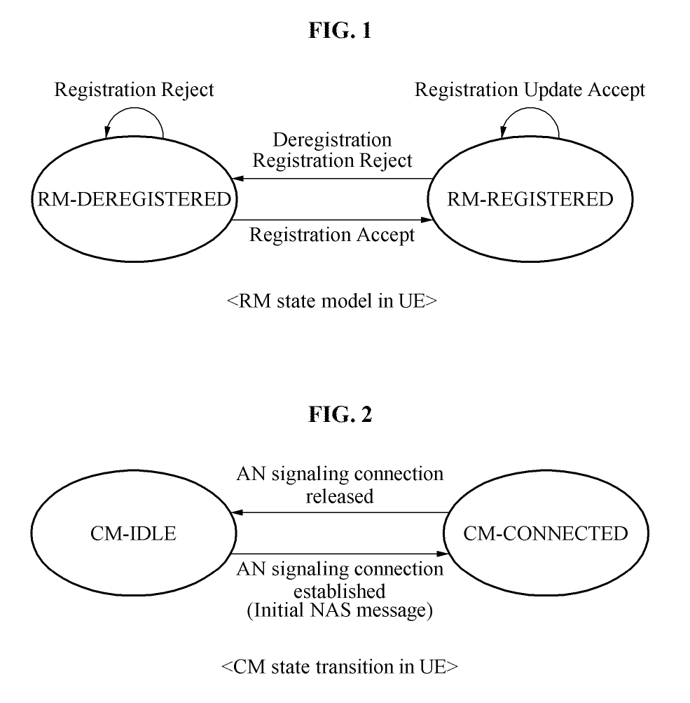

FIG. 1 illustrates an example of a registration management (RM) state model of a UE according to an example embodiment.

1. RM-DEREGISTERED State

In the RM-DEREGISTERED state, the UE is not registered with a network. A UE context in an AMF device holds no valid location or routing information for the UE. Therefore, the UE may not be reachable by the AMF device. However, a portion of the UE context may be stored in the UE and the AMF device, for example, to avoid running an authentication procedure during every registration procedure.

In the RM-DEREGISTERED state, the UE may i) attempt to register with the selected PLMN using the initial registration procedure if the UE needs to receive a service that requires registration; ii) remain in the RM-DEREGISTERED state if the UE receives a registration reject upon initial registration; and iii) enter an RM-REGISTERED state in response to receiving a registration accept.

When a UE RM state of the AMF device is RM-DEREGISTER, the AMF device may i), if applicable, accept the initial registration of the UE by sending a registration accept to the UE and enter the RM-REGISTERED state for the UE; or ii), if applicable, reject the initial registration of the UE by sending a registration reject to the UE.

2. RM-REGISTERED State

In the RM-REGISTERED state, the UE is registered with the network. In the RM-REGISTERED state, the UE may receive a service that requires registration with the network.

In the RM-REGISTERED state, the UE may i) perform a mobility registration update procedure if a current TAI of a servicing cell is absent in a list of TAIs that the UE receives from the network to maintain the registration and enable the AMF device to page the UE; ii) perform a periodic registration update procedure triggered by expiry of a periodic update timer to notify the network that the UE is still active; iii) perform a registration update procedure to update its capability information or to re-negotiate parameters with the network; iv) perform a deregistration procedure and enter the RM-DEREGISTERED state when the UE needs to be no longer registered with the PLMN (the UE may determine to deregister from the network at any time); and v) enter the RM-DEREGISTERED state in response to receiving a registration reject message or a deregistration message. The actions of the UE depend on a cause value in a registration rejection message or a deregistration message.

When the UE RM state of the AMF device is RM-REGISTERED, the AMF device may i) perform a deregistration procedure and enter the RM-DEREGISTERED state for the UE when the UE needs to be no longer registered with the PLMN (the network may determine to deregister the UE at any time); ii) perform an implicit deregistration at any time after expiry of an implicit deregistration timer, and enter the RM-DEREGISTERED state for the UE after the Implicit deregistration; and iii), if applicable, accept or reject a registration request or a service request from the UE.

<Connection Management>

The connection management is used to establish or release a signaling connection between the UE and the AMF device. The connection management includes a function of establishing and releasing the signaling connection between the UE and the AMF device over N1.

The signaling connection is used to enable NAS signaling exchange between the UE and the core network, and includes an access network (AN) signaling connection between the UE and the AN (an RRC connection over a 3GPP access or a UE-N3IWF connection over a non-3GPP access) and an N2 connection for the UE between the AN and the AMF device.

The following CM states are used to reflect a NAS signaling connection between the AMF device and the UE:

1) CM-IDLE; and 2 CM-CONNECTED.

The CM states for the 3GPP access and the non-3GPP access are mutually independent. That is, if one is in the CM-CONNECTED state, the other may be in the CM-IDLE state at the same time.

FIG. 2 illustrates an example of a connection management (CM) state transition in a UE according to an example embodiment.

1. CM-IDLE State

A UE in the CM-IDLE state has no signaling connection established with an AMF device over N1. The UE performs a cell selection/cell reselection and performs a PLMN selection.

The UE in the CM-IDLE state has no AN signaling connection, N2 connection, and N3 connection.

If the UE is in the CM-IDLE state and the RM-REGISTERED state, the UE may i) respond to paging by performing a service request procedure unless the UE is in a MICO mode; and ii) perform a service request procedure when the UE has uplink signaling or user data to be sent. Specific conditions are applied to LADN.

The UE may enter the CM-CONNECTED state every time an AN signaling connection is established between the UE and the AN. The UE may enter an RRC connected state over the 3GPP access or at the establishment of a UE-N3IWF connectivity over the non-3GPP access. Sending of an initial NAS message, for example, a registration request message, a service request message, or a deregistration request message, initiates a transition from the CM-IDLE state to the CM-CONNECTED state.

When the UE states in the AMF device are CM-IDLE and RM-REGISTERED, the AMF device may i) perform a network triggered service request procedure when the AMF device has signaling or mobile-terminated data to be sent to the UE by sending a paging request to the UE if the UE is not prevented from responding.

The AMF device may enter the CM-CONNECTED state for the UE every time an N2 connection is established for the UE between the AN and the AMF device.

Receiving of an initial N2 message, for example, an N2 initial UE message, initiates transition of the AMF device from the CM-IDLE state to the CM-CONNECTED state.

The UE and the AMF device may optimize the power efficiency and the signaling efficiency of the UE when the UE and the AMF device are in the CM-IDLE state.

2. CM-CONNECTED State

The UE in the CM-CONNECTED state has a NAS signaling connection with the AMF device over N1. The NAS signaling connection uses an RRC connection between the UE and an NG-RAN and an NGAP UE association between the AN and the AMF device. The UE may be in the CM-CONNECTED state with the NGAP UE association that is not bound to any TNLA between the AN and the AMF device. In response to completion of a NAS signaling procedure, the AMF device may determine to release the NAS signaling connection with the UE:

In the CM-CONNECTED state, the UE may i) enter the CM-IDLE state every time the AN signaling connection is released (enter an RRC idle state over the 3GPP access or when release of UE-N3IWF connectivity over the non-3GPP access is detected by the UE).

When a UE CM state in the AMF device is CM-CONNECTED, the AMF device may i) enter the CM-IDLE state for the UE every time a logical NGAP signaling connection and an N3 user plane connection for the UE are released in response to completion of the AN release procedure.

The AMF device may maintain the UE CM state in the AMF device to be in the CM-CONNECTED state until the UE deregisters from a core network.

The UE in the CM-CONNECTED state may be in an RRC inactive state. When the UE is in the RRC inactive state, the following applies i) UE reachability is managed by a RAN with assistance information from the core network; ii) UE paging is managed by the RAN; and iii) the UE monitors paging with a RAN identifier and CN (5G S-TMSI) of the UE.

<Session Management>

A 5G core network supports a PDU connectivity service. The PDU connectivity service is supported through PDU sessions that are established in response to a request from the UE.

Subscription information may include a plurality of data network names (DNNs) and a default DNN. The UE is assigned to the default DNN if a valid DNN is not provided in a PDU session establishment request sent to the 5G core network.

Each PDU session supports a single PDU session type. That is, each PDU session supports exchange of a single type of a PDU session requested by the UE at the establishment of the PDU session.

The PDU session may be established in response to a request from the UE, modified response to a request from the UE and the 5GC, and released in response to a request from the UE and the 5GC using NAS SM signaling exchanged over N1 between the UE and the SMF device. In response to a request from an application server, the 5GC may trigger a specific application in the UE. In response to receiving that trigger message, the UE may transfer the received message to an application identified in the UE. The identified application may establish a PDU session with respect to a specific DNN.

The SMF device may support a PDU session for a LADN in which an access to a data network is available in a specific LADN service area.

The SMF device may verify whether a UE request is compliant with a user subscription. For this purpose, the SMF device may retrieve and request update notifications on SMF device level subscription data from a UDM. Such data may indicate the following per DNN and, if applicable, per single network slice selection assistance information (S-NSSAI) i) allowed PDU session types and a default PDU session type; ii) allowed SSC modes and a default SSC mode; iii) QoS information, such as subscribed session-AMBR, default 5QI and default ARP; and iv) a static IP address/prefix.

The UE that is registered over multiple accesses selects an access used to establish a corresponding PDU session. An HPLMN may send a policy to the UE to guide the UE selection of the access over which to establish the corresponding PDU session.

The UE may request to move a PDU session between the 3GPP access and the non-3GPP access. A determination to move the PDU session between the 3GPP access and the non-3GPP access is made based on a PDU session unit. That is, the UE may have some PDU sessions using the 3GPP access at a given time, while other PDU sessions are using the non-3GPP access.

In a PDU session establishment request sent to the network, the UE may provide a PDU session identifier (ID). The PDU session ID is unique per UE and is used to uniquely identify a single PDU session from among PDU sessions of the UE. The PDU session ID may be stored in the UDM to support a handover between the 3GPP access and the non-3GPP access. The UE may also provide i) a PDU session type; ii) S-NSSAI, iii) a DNN; and iv) an SSC mode.

The UE may establish a plurality of PDU sessions in the same data network or different data networks, through 3GPP and non-3GPP access networks at the same time.

The UE may establish the plurality of PDU sessions in the same data network and may be served by a different UPF device that terminates N6.

The UE with the established plurality of PDU sessions may be served by a different SMF device.

The SMF device may be registered and deregistered based on a unit of a PDU session granularity in the UDM.

User plane paths of different PDU sessions (to the same or to different DNNs) belonging to the same UE may be completely disjointed between the AN and the UPF device interfacing with the DN.

<Registration Management Procedures>

<General>

The UE needs to register with a network to be authorized to receive services and to enable mobility tracking and reachability.

The registration procedure may be used when the UE needs to perform an initial registration to the communication system according to example embodiments or to perform a mobility registration update in response to changing to a new tracking area (TA) outside a registration area of the UE in both a CM_CONNECTED mode and a CM_IDLE mode, when the UE performs a periodic registration update (due to a predefined time period of inactivity), and additionally when the UE needs to update capabilities or protocol parameters of the UE that are negotiated in the registration procedure.

Although the following general registration call flow may apply to all of the registration procedures, the periodic registration does not need to include all parameters that are used in other registration cases.

The following general registration call flow may be used for emergency registration by UEs required to perform emergency services, however, incapable of receiving normal services from the network. The UEs may be in a limited service state defined in TS 23.122.

During the initial registration, a peripheral equipment interface (PEI) may be acquired from the UE. An operator of the AMF device may verify the PEI with an equipment identity register (EIR). The AMF device may transfer the PEI (IMEISV) to the UDM device, and to the SMF device and the PCF device. The UDM device may store data in a UDR device by Nudr_SDM_Update. An NSI ID may be optionally used in the communication system and may depend on a deployment selection of the operator.

<General Registration>

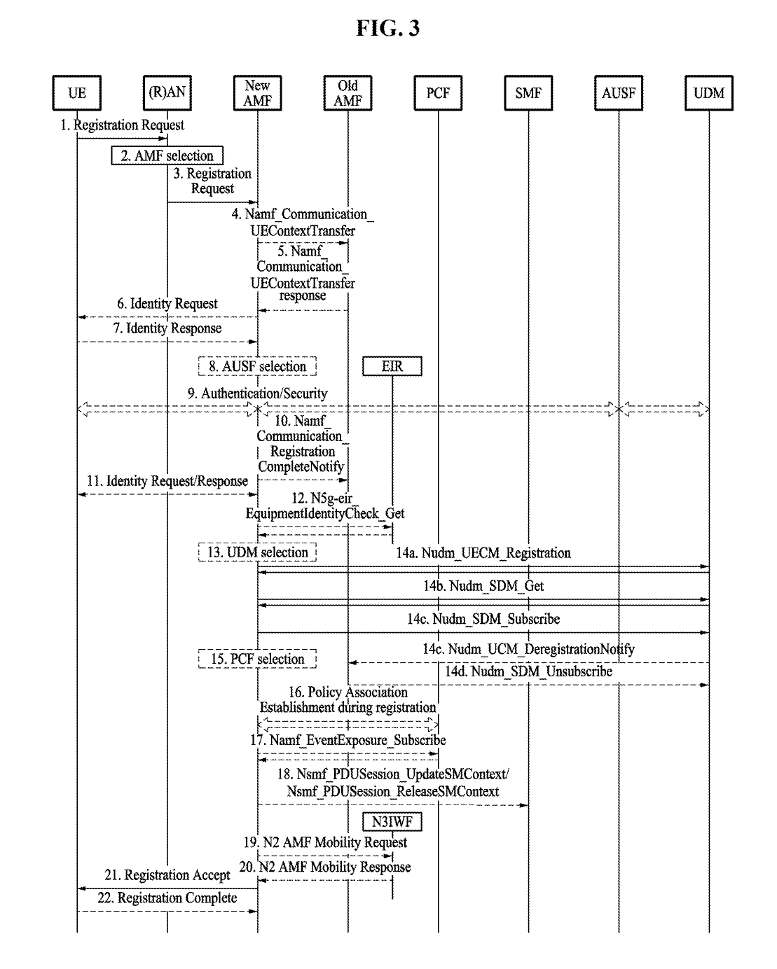

FIG. 3 illustrates an example of a UE registration procedure in a communication system according to an example embodiment.

Referring to FIG. 3, in operation 1, the UE may send, to the (R)AN, an AN message (AN parameters, RM-NAS registration request (registration type, subscription concealed identifier (SUCI), SUPI or 5G-GUTI, last visited TAI (if available), security parameters, requested NSSAI, mapping of requested NSSAI, UE 5GC capability, PDU session status, PDU session(s) to be re-activated, follow-on request, and MICO mode preference).

In the case of NG-RAN, the AN parameters may include, for example, the SUCI, the SUPI or the 5G-GUTI, a selected PLMN ID, and the requested NSSAI. The AN parameters may include an establishment cause. The establishment cause may provide a reason for requesting establishment of an RRC connection.

The registration type may indicate whether the UE desires to perform an initial registration (i.e., the UE is in an RM-DEREGISTERED state), a mobility registration update (i.e., the UE is in an RM-REGISTERED state and initiates a registration procedure due to mobility), a periodic registration update (i.e., the UE is in the RM-REGISTERED state and initiates the registration procedure due to expiry of a periodic registration update timer) or an emergency registration (i.e., the UE is in a limited service state). The UE may perform the initial registration (i.e., the UE is in the RM-DEREGISTERED state) to a PLMN for which the UE does not have the 5G-GUTI. The UE may include the SUCI or SUPI of the UE in the registration request. The SUCI may be included only if a home network provides a public key to protect the SUPI in the UE. If a UE configuration update command indicating that the UE needs to re-register and the 5G-GUTI is invalid is received at the UE, the UE may perform the initial registration and may include the SUPI in the registration request message. For the emergency registration, the SUPI may be included if the UE does not have the SUPI and a valid 5G-GUTI SUPI. A PEI may be included when the UE does not have the SUPI and the valid 5G-GUTI SUPI. In other cases, the 5G-GUTI may be included and may indicate a last serving AMF device. If the UE is already registered over the non-3GPP access in a PLMN different from the new PLMN (i.e., not the registered PLMN or an equivalent PLMN of the registered PLMN) of the 3GPP access, the UE may not provide, over the 3GPP access, the 5G-GUTI allocated by the AMF device during the registration procedure over the non-3GPP access. Also, if the UE is already registered over the 3GPP access in the PLMN (i.e., the registered PLMN), different from the new PLMN (i.e., not the registered PLMN or the equivalent PLMN of the registered PLMN) of the non-3GPP access, the UE may not provide, over the non-3GPP access, the 5G-GUTI allocated by the AMF during the registration procedure over the 3GPP access. The UE may provide a usage setting of the UE based on the configuration of the UE. In the case of the initial registration or the mobility registration update, the UE may include mapping of the requested NSSAI, which is mapping of each S-NSSAI of the requested NSSAI to the S-NSSAI of the configured NSSAI for the HPLMN, to ensure that the network is able to verify whether the S-NSSAI(s) in the requested NSSAI are permitted based on the subscribed S-NSSAI.

If available, the last visited TAI may be included to help the AMF procedure registration area for the UE.

The security parameters may be used for authentication and integrity protection. The requested NSSAI represents network slice selection assistance information. The PDU session status indicates previously established PDU sessions in the UE. When the UE is connected to two AMF devices belonging to different PLMNs over the 3GPP access and the non-3GPP access, the PDU session state indicates an established PDU session of a current PLMN in the UE. PDU session(s) to be re-activated may be included to indicate the PDU session(s) for which the UE intends to activate UP connections. A PDU session corresponding to a LADN may not be included in the PDU session(s) to be re-activated corresponding to the LADN when the UE is outside an area in which the LADN is available. The follow-on request may be included when the UE has pending uplink signaling and does not include PDU session(s) to be re-activated, or when the registration type indicates that the UE desires to perform the emergency registration. HO attach indication may be added.

In operation 2, if the SUPI is included or if the 5G-GUTI does not indicate the valid AMF device, the (R)AN may select the AMF device based on the (R)AT and requested NSSAI.

The (R)AN may select the AMF device. If the UE is in a CM-CONNECTED state, the (R)AN may forward a registration request message to the AMF device based on an N2 connection of the UE. If the (R)AN is incapable of selecting an appropriate AMF device, the (R)AN may forward, to the AMF device, a registration request that is configured in the (R)AN to perform AMF device selection.

In operation 3, the (R)AN may send, to a new AMF device, an N2 message (N2 parameters, RM-NAS registration request (registration type, SUPI or 5G-GUTI, last visited TAI (if available), security parameters, requested NSSAI, mapping of requested NSSAI, UE 5GC capability, PDU session status, PDU session(s) to be re-activated, follow-on request, and MICO mode preference)).

When the NG-RAN is used, the N2 parameters may include a selected PLMN ID, location information, a cell identity and a RAT type related to a cell in which the UE is camping. When the NG-RAN is used, the N2 parameters may also include an establishment cause. If the registration type indicated by the UE is periodic registration update, operations 4 to 17 may be omitted.

In operation 4 that is conditionally performed, the new AMF device may send Namf_Communication_UEContextTransfer (complete registration request) to an old AMF device.

If the 5G-GUTI of the UE is included in the registration request and a serving AMF device is changed since a last registration procedure, the new AMF device may invoke an Namf_Communication_UEContextTransfer service operation on the old AMF device, including a complete registration request IE, which may be integrity protected, to request the SUPI and MM context of the UE. The old AMF device may use the integrity protected complete registration request IE to verify whether a context transfer service operation invocation corresponding to the UE is requested.

The old AMF device may transfer event subscription information by each NF consumer, for the UE, to the new AMF device. Once the UE is successfully registered with the new AMF device, the NF consumers do not need to subscribe for an event once again with the new AMF device.

If the new AMF device has already received UE contexts from the old AMF device during a handover procedure, operations 4, 5, and 10 may be omitted.

For the emergency registration, if the UE identifies the UE itself with a 5G-GUTI that is not known to the AMF device, operations 4 and 5 may be omitted. The AMF device may immediately request the UE for the SUPI. If the UE identifies the UE itself with the PEI, the SUPI request may be omitted. Allowing the emergency registration without a user identity may depend on local regulations.

In operation 5 that is conditionally performed, the old AMF device may send a response to Namf_Communication_UEContextTransfer (SUPI, MM context, SMF information, PCF ID) to the new AMF device.

The old AMF device may respond to the new AMF device for the Namf_Communication_UEContextTransfer invocation by including the SUPI and the MM context of the UE. If the old AMF device holds information about established PDU sessions, the old AMF device may include SMF information including S-NSSAI(s), SMF identities and PDU session ID. If the old AMF device holds information about active NGAP UE-TNLA bindings to N3IWF, the old AMF device may include information about the NGAP UE-TNLA bindings.

In operation 6 that is conditionally performed, an identity request may be sent from the new AMF device to the UE device. If the SUPI is not provided from the UE or not retrieved from the old AMF device, an identity request procedure may be initiated in such a manner that the AMF device sends an identity request message to the UE requesting the SUCI.

In operation 7 that is conditionally performed, an identity response may be sent from the UE to the new AMF device. The UE may respond with an identity response message including the SUCI. The UE may derive the SUCI using a provisioned specific public key of the HPLMN.

In operation 8, the AMF device may determine to initiate UE authentication by invoking an AUSF. In this case, the AMF device may select the AUSF based on the SUPI or the SUCI.

If the AMF device is configured to support the emergency registration for unauthenticated SUPIs and the UE indicated registration type emergency registration, the AMF device may skip the authentication and security setup. Alternatively, the AMF device may accept that the authentication may fail, and may continue the registration procedure.

In operation 9, the AUSF device may execute authentication of the UE.

The authentication may be performed as described by the Nudm_UEAuthenticate_Get operation. The AUSF device may discover a UDM. When the AMF device provides the SUCI to the AUSF device, the AUSF device may return the SUPI to the AMF device after the authentication succeeds.

If network slicing is used, the AMF device may determine whether the registration request in which the initial AMF device refers to the AMF device needs to be rerouted.

Also, in operation 9, the AMF device may initiate NAS security functions.

Also, in operation 9, once the NAS security function setup is completed, the AMF device may initiate an NGAP procedure so that 5G-AN may use it for security procedures with the UE.

Also, in operation 9, the 5G-AN may store the security context and may make acknowledgment to the AMF device. The 5G-AN may use the security context to protect the messages exchanged with the UE.

In operation 10 that is conditionally performed, the new AMF device may send Namf_Communication_RegistrationCompleteNotify to the old AMF device.

If the AMF device is changed, the new AMF device may notify the old AMF that the registration of the UE in the new AMF device is completed by invoking an Namf_Communication_RegistrationCompleteNotify service operation.

If the authentication/security procedure fails, the registration may be rejected, and the new AMF device may invoke the Namf_Communication_RegistrationCompleteNotify service operation with a reject indication reason code towards the old AMF device. The old AMF device may continue as if the UE context transfer service operation is not received.

If at least one of the S-NSSAI used in the old registration area may not be served in a target registration area, the new AMF device may determine which PDU session may not be supported in the new registration area. The new AMF device may invoke the Namf_Communication_RegistrationCompleteNotify service operation including the rejected PDU session ID and a reject cause (e.g., the S-NSSAI becomes no longer available) towards the old AMF device. In this case, the new AMF device may modify the PDU session status correspondingly. The old AMF device may inform corresponding SMF(s) to locally release the SM context of the UE by invoking the Nsmf_PDUSession_ReleaseSMContext service operation.

In operation 11 that is conditionally performed, an identity request/response (PEI) may be sent from the new AMF device to the UE.

If the PEI is not provided from the UE or not retrieved from the old AMF device, the identity request procedure may be initiated by the AMF device sending an identity request message to the UE to retrieve the PEI. The PEI may be encrypted and thereby transferred unless the UE performs emergency registration and may not be authenticated. For the emergency registration, the UE may include the PEI in the registration request. In this case, the PEI retrieval may be omitted.

In operation 12, the new AMF device may initiate a ME identity check by invoking the N5g-eir_EquipmentIdentityCheck_Get service operation. For the emergency registration, if the PEI is blocked, operator policies may be used to determine whether to continue or stop the emergency registration procedure.

If operation 14 is to be performed, the new AMF device may select a UDM device based on the SUPI in operation 13. In this case, the UDM may select a UDR instance.

In operations 14a and 14b, if the AMF device is changed since the last registration procedure, if the UE provides a SUPI that does not refer to a valid context in the AMF device, or if the UE registers to the same AMF device that is already registered to the non-3GPP access (i.e., the UE is registered over the non-3GPP access and initiates this registration procedure to add the 3GPP access), the new AMF device may register with the UDM device using Nudm_UECM_Registration and may subscribe to be notified when the UDM device deregisters this AMF device. The UDM device may store an AMF identity associated with an access type and may not remove the AMF identity associated with another access type. UDM device may store information provided at registration in UDR, by Nudr_UDM_Update.

The AMF device may retrieve access and mobility subscription data and SMF selection subscription data using Nudm_SDM_Get. This requires that the UDM device may retrieve this information from the UDR by Nudr_UDM_Query (access and mobility subscription data). After a successful response is received, the AMF device may subscribe to be notified using Nudm_SDM_Subscribe when the data requested is modified and the UDM may subscribe to UDR by Nudr_UDM_Subscribe. The GPSI may be provided to the AMF device in the subscription data from the UDM device if the GPSI is available in the UE subscription data.

The new AMF device may provide the UDM device with the access type the new AMF device serves for the UE. Here, the access type may be set to “3GPP access.” The UDM device may store the associated access type together with the serving AMF device in UDR by Nudr_UDM_Update.

The new AMF device may create an MM context for the UE after acquiring the mobility subscription data from the UDM device. For the emergency registration in which the UE is not successfully authenticated, the AMF device may not register with the UDM device. For the emergency registration, the AMF device may not verify access restrictions, regional restrictions, or subscription restrictions. For the emergency registration, the AMF device may ignore an unsuccessful registration response from the UDM device and continue with the registration procedure.

In operation 14c, when the UDM device stores the associated access type together with the serving AMF device as indicated in operation 14a, it may cause the UDM device to initiate Nudm_UECM_DeregistrationNotification to the old AMF device corresponding to the 3GPP access, if one exists. The old AMF device may remove the MM context of the UE. If a serving NF removal reason indicated by the UDM device is initial registration, the old AMF may invoke an Namf_EventExposure_Notify service operation towards all the associated SMF devices of the UE to notify that the UE is deregistered from the old AMF device. The SMF device may release the PDU session(s) in response to receiving the notification.

In operation 14d, the old AMF device may cancel subscription to, that is, unsubscribe from the UDM device for subscription data using Nudm_SDM_unsubscribe.

In operation 15, if the AMF device determines to initiate PCF communication, for example, if the AMF device has not yet acquired an access and mobility policy for the UE or if the access and mobility policy in the AMF device is no longer valid, the AMF device may select a PCF device. If the new AMF device receives a PCF ID from the old AMF device in operation 5 and successfully contacts with the PCF device identified based on the PCF ID, the AMF device may select the (V-)PCF identified based on the PCF ID. If the PCF device identified by the PCF ID is unavailable (e.g., no response from the PCF device) or if there is no PCF ID received from the old AMF device in operation 5, the AMF device may select the PCF device.

In operation 16 that is optionally performed, the new AMF device may performs a policy association establishment during the registration procedure. Operation 16 may be omitted for the emergency registration.

If the new AMF device contacts with the PCF device identified based on the (V-)PCF ID received during inter-AMF mobility in operation 5, the new AMF device may include the PCF-ID in an Npcf_AMPolicyControl Get operation. This indication may not be included by the AMF device during the initial registration procedure.

If the AMF device notifies mobility restrictions (e.g., UE location) to the PCF device for adjustment, or if the PCF device updates the mobility restrictions due to some conditions (e.g., application in use, time and date), the PCF device may provide the updated mobility restrictions to the AMF device.

In operation 17, the PCF device may invoke the Namf_EventExposure_Subscribe service operation for UE event subscription.

In operation 18 that is conditionally performed, from the AMF device may send Nsmf_PDUSession_UpdateSMContext to the SMF device.

For the emergency registered UE, operation 18 may be applied when the registration type is mobility registration update.

The AMF device may invoke Nsmf_PDUSession_UpdateSMContext in the following scenario(s):

If the “PDU session(s) to be re-activated” is included in the registration request in operation 1, the AMF device may send an Nsmf_PDUSession_UpdateSMContext request to the SMF device(s) associated with the PDU session(s) to activate user plane connections of the PDU session(s). The UE triggered service request executed onwards from operation 5 may be executed to complete the user plane connection activation without sending an MM NAS service accept from the AMF device to (R)AN.

The SMF device may determine to trigger (e.g., intermediate UPF insertion) removal or change of PSA. In the case that insertion, removal, or relocation of the intermediate UPF device is performed for PDU session(s) not included in the “PDU session(s) to be re-activated,” the procedure may be performed without N11 and N2 interactions to update the N3 user plane between (R)AN and the SGC.

The AMF device may invoke an Nsmf_PDUSession_ReleaseSMContext service operation towards the SMF device in the following scenario:

If any PDU session status indicates that it is released at the UE, the AMF device may invoke an Nsmf_PDUSession_ReleaseSMContext service operation towards the SMF device to release network resources related to the PDU session.

If the registration type indicated by the UE is periodic registration update, operation 20 may be omitted.

If the serving AMF device is changed, the new AMF device may wait until operation 17 is terminated with respect to all the SMF devices associated with the UE. Otherwise, operations 18 to 22 may continue in parallel to this operation.

The mobility related event notifications towards the NF consumers may be triggered at the end of this procedure.

In operation 19, the new AMF device may send an N2 AMF mobility request to N3IWF. If the AMF device is changed, the new AMF device may create an NGAP UE association towards the N3IWF to which the UE is connected.

In operation 20, the N3IWF may send an N2 AMF mobility response to the new AMF device.

In operation 21, the new AMF device may send, to the UE, a registration accept (5G-GUTI, registration area, mobility restrictions, PDU session status, allowed NSSAI, (mapping of allowed NSSAI), periodic registration update timer, LADN information and accepted MICO mode, IMS voice over PS session supported indication, emergency service support indicator).

The AMF device may send a registration accept message to the UE indicating that the registration request is accepted. If the AMF device allocates a new 5G-GUTI, the 5G-GUTI may be included. If the AMF device allocates a new registration area, the AMF device may send the registration area to the UE using the registration accept message. If no registration area is included in the registration accept message, the UE may consider the old registration area as valid. Mobility restrictions may be included if mobility restrictions apply for the UE and the registration type is not emergency registration. The AMF device may indicate the established PDU sessions to the UE in the PDU session status. The UE may locally remove any internal resources related to PDU sessions that are not marked as established in the received PDU session status. When the UE is connected to the two AMF devices belonging to different PLMNs over the 3GPP access and the non-3GPP access, the UE may locally remove any internal resources related to the PDU session of the current PLMN not marked as established in the received PDU session status. If the PDU session status information is included in the registration request, the AMF device may indicate the PDU session status to the UE. The mapping of allowed NSSAI may be mapping of each piece of S-NSSAI of the allowed NSSAI to the S-NSSAI of the configured NSSAI for the HPLMN. The AMF device may include LADN information for LADNs in the registration accept message. The LADN information for the LADNs may be available within the registration area determined by the AMF device for the UE. If the UE included MICO mode is in the request, the AMF device may respond regarding whether the MICO mode needs to be used. The AMF device may set the IMS voice over PS session supported indication. To set the IMS voice over PS session supported indication, the AMF device may need to perform the UE/RAN radio information and compatibility request procedure to verify the compatibility of the UE and RAN radio capabilities related to IMS voice over PS. If the AMF device does not receive a voice support match indicator from the NG-RAN on time, the AMF device may set the IMS voice over PS session supported indication and may update the same at a later stage based on implementation. The emergency service support indicator may inform the UE that emergency services are supported. For example, the UE may be allowed to request a PDU session for emergency services.

In operation 21, a handover restriction list and UE-AMBR may be provided from the AMF device to the NG-RAN.

For the emergency registered UE, no AS security context information may be included in an N2 control message and no NAS level security may be present when the UE is not authenticated.

In operation 22 that is conditionally performed, the UE may send a registration complete message to the new AMF device.

The UE may send the registration complete message to the AMF device in response to assignment of the new 5G-GUTI. When the “PDU session(s) to be re-activated” is not included in the registration request, the AMF device may release the signaling connection with the UE. When the follow-on request is included in the registration request, the AMF device may not release the signaling connection after the completion of the registration procedure. If the AMF device is aware that some signaling is pending in the AMF device or between the UE and the 5GC, the AMF device may not release the signaling connection immediately after the completion of the registration procedure.

<Network Sharing)>

1. General Concepts

A network sharing architecture may allow multiple participating operators to share resources of a single shared network according to agreed allocation schemes. The shared network includes a radio access network. The shared resources include radio resources.

The shared network operator may allocate shared resources to the participating operators based on their planned and current needs and according to service level agreements.

Only the 5G multi-operator core network (5G MOCN) network sharing architecture in which only the RAN is shared in 5G system is supported. 5G MOCN for 5G system, including UE, RAN and the AMF devices, may support operators' ability to use more than one PLMN ID.

2. Network Selection

A UE that subscribes to one of the sharing core network operators may be able to select this core network operator while within the coverage area of the shared network and to receive subscribed services from that core network operator.

Each cell in shared NG-RAN may include, in broadcast system information, the PLMN-IDs concerning available core network operators in the shared network.

When a UE performs an initial registration to a network, one of available PLMNs may be selected to serve the UE. The UE may use all the received broadcast PLMN-IDs in its PLMN (re)selection processes. The UE may inform the NG-RAN of the selected PLMN so that the NG-RAN may route correctly. The NG-RAN may inform the core network of the selected PLMN.

As per any network, after initial registration to the shared network and while remaining served by the shared network, the UE may not change to another available PLMN as long as the selected PLMN is available to serve the UE's location. The network selection procedures may cause the UE to perform a reselection of another available PLMN. Also the network may not move the UE to another available PLMN as long as the selected PLMN is available to serve the UE's location.

3. Network Sharing and Network Slicing

A network Slice is defined within a PLMN. Network sharing is performed among different PLMNs. In case of network sharing, each PLMN sharing the NG-RAN defines and supports its PLMN-specific set of slices that are supported by the common NG-RAN.

A network slicking introduced herein according to an example embodiment may follow as:

The network slice may include the following:

core network control plane and user plane network functions.

5G radio access network

N3IWF may function to a non-3GPP access network.

Network slices may differ for supported features and network function optimizations. The operator may deploy multiple network slice instances delivering exactly the same features but for different groups of UEs, for example, as the network slices deliver a different committed service and/or because the network slices may be dedicated to a customer.

A single UE may simultaneously be served by one or more network slice instances through a 5G-AN. The AMF instance serving the UE logically belongs to each of the network slice instances serving the UE. That is, this AMF instance may be common to the network slice instances serving the UE.

A PDU session may belong to a specific network slice instance. Different network slice instances do not share a PDU session, though different slices may have slice-specific PDU sessions using the same DNN.

Identification and Selection of Network Slice: S-NSSAI and NSSAI

Single network slice selection assistance information (S-NSSAI) may identify a network slice.

The S-NSSAI may include:

slice/service type (SST), which refers to an expected network slice behavior in terms of features and services; and

slice differentiator (SD), which is optional information that complements the slice/service type(s) to allow further differentiation for selecting a network slice instance from the potentially multiple network slice instances that all comply with the indicated slice/service type. This information is referred to as SD.

The S-NSSAI may have standard values or PLMN-specific values. S-NSSAI with PLMN-specific values are associated to a PLMN ID of a PLMN that assigns it. S-NSSAI may not be used by a UE in access stratum procedures in any PLMN other than the one with which the S-NSSAI is associated.

The NSSAI is a collection of S-NSSAI that refers to single network slice selection assistance information. Each piece of S-NSSAI may assist the network in selecting a particular network slice instance. A CN part of a network slice instance(s) serving a UE is selected by a CN not by a RAN.

The (R)AN may use requested NSSAI in an access stratum signaling to handle UE control plane connection before the 5GC informs the (R)AN of allowed NSSAI. The requested NSSAI is not used by the RAN for routing when the UE provides a temporary user ID.

When the UE is successfully registered, the CN informs the (R)AN by providing the allowed NSSAI in terms of the control plane.

When a PDU session for a specific slice instance is established, the CN may provide the (R)AN with S-NSSAI corresponding to a network slice instance to which the PDU session belongs, enable the RAN to perform access specific functions.

Subscription Aspects

Subscription data may include S-NSSAI of network slices that the UE subscribes to. One or more pieces of S-NSSAI may be marked as default S-NSSAI. If S-NSSAI is marked as default, the network is expected to serve the UE with the related network slice even when the UE does not send any S-NSSAI to the network in a registration request.

The UE subscription data may include a default DNN value for given S-NSSAI.

The NSSAI the UE provides in the registration request is verified against the user's subscription data.

UE NSSAI Configuration and NSSAI Storage Aspects

A UE may be configured by an HPLMN with NSSAI per PLMN. Configured NSSAI may be PLMN-specific and the HPLMN indicates each configured NSSAI applies which PLMN(s) including whether the configured NSSAI applies to all PLMNs. The configured NSSAI may deliver the same information regardless of a PLMN the UE accesses (e.g., it could be possible for NSSAI including only S-NSSAI with standard values). When providing requested NSSAI upon registration, a UE in a given PLMN may need to use only S-NSSAI belonging to the configured NSSAI.

When a UE's registration procedure is successfully completed, the UE may obtain allowed NSSAI for the PLMN, which includes one or more pieces of S-NSSAI, from the AMF device. The allowed NSSAI may prioritize the configured NSSAI for the PLMN. The UE may need to use only S-NSSAI in the allowed NSSAI corresponding to a network slice for a subsequent network slice selection procedure in a serving PLMN.

For each PLMN, the UE may store the configured NSSAI and, if allowed, may need to store NSSAI. If the UE receives allowed NSSAI for the PLMN, the UE may store the PLMN and may override any previously stored allowed NSSAI for the PLMN.

Establishment of user plane connectivity to a data network through a network slice instance(s) may include the following two operations:

performing an RM procedure to select an AMF device that supports a required network slice instance(s); and

establishing one or more PDU sessions to the required data network through the network slice instance(s).

Selection of Serving AMF Supporting Network Slice

A registration to a set of network slices

UE with configured or allowed NSSAI for a PLMN

When a UE registers with a PLMN, if the UE for this PLMN has configured NSSAI or allowed NSSAI, the UE may need to provide the network in RRC and NAS layer with requested NSSAI that includes S-NSSAI (e.g., for the UE). If a temporary user ID is assigned to the UE, a slice(s) to which the UE desires to register may be included in addition to the temporary user ID.

The requested NSSAI may be one of the following:

configured NSSAI or a subset thereof if the UE does not have allowed NSSAI for a current PLMN; or

allowed NSSAI or a subset thereof if the UE has allowed NSSAI for the current PLMN,

allowed NSSAI or a subset thereof, which is described below, plus at least one S-NSSAI, from the configured-NSSAI for which no corresponding S-NSSAI is present in the allowed NSSAI and that were not previously rejected in the PLMN by the network.

The subset of configured-NSSAI provided in the requested NSSAI may include at least one piece of S-NSSAI in the configured NSSAI applicable to this PLMN, if the S-NSSAI was not previously rejected in the PLMN by the network.

The subset of allowed NSSAI may include at least one piece of S-NSSAI included in last allowed NSSAI for this PLMN.

The UE may provide S-NSSAI from configured NSSAI that was previously provided from the UE for a serving PLMN in a current registration area, for the requested NSSAI.

The UE may need to include the requested NSSAI at RRC connection establishment and in NAS messages. The RAN may need to route NAS signaling between the UE and an AMF device selected using the requested NSSAI obtained during the RRC connection establishment. If the RAN is unable to select an AMF device based on the requested NSSAI, the RAN may route the NAS signaling to the AMF device from a set of default AMF devices.

Upon successful registration, the UE is provided with temporary ID from a serving AMF device. The UE may include the temporary ID in any RRC connection establishment during a subsequent initial access to enable the RAN to route NAS signaling between the UE and an appropriate AMF device.

The serving PLMN may return new allowed NSSAI that identifies an allowed network slice by the serving PLMN for the UE. The UE may store the new allowed NSSAI and may need to ignore previously stored allowed NSSAI for the PLMN.

The network may individually reject S-NSSAI provided by the UE from the requested NSSAI as a rejected reason. The network may also indicate whether the rejection is permanent (e.g., S-NSSAI is not supported by a PLMN in a current registration area) or temporary (e.g., network slice corresponding to S-NSSAI is temporarily unavailable).

When the requested NSSAI and temporary ID in RRC are received from the UE, and if the RAN may reach an AMF device corresponding to the temporary ID, the RAN may transmit a request to the AMF device. Otherwise, the RAN may select an appropriate AMF device based on the requested NSSAI provided by the UE and may forward the request to the selected AMF device. If the RAN is unable to select the AMF device based on the requested NSSAI, the request may be set to a default AMF device. UE Not Having NSSAI for PLMN

When a UE registers with a PLMN, if for this PLMN the UE does not have configured NSSAI or allowed NSSAI, the RAN may route all UE signaling from/to the UE to/from a default AMF device. If the configured NSSAI or the allowed NSSAI is absent for the corresponding PLMN, the UE may not indicate NSSAI in an RRC connection establishment or an initial NAS message. If registration is successfully completed, the UE may include receiving allowed NSSAI that identifies an allowed slice by a serving PLMN with respect to a portion of subscribed default S-NSSAI) and a temporary ID by an AMF device within a subscriber PLMN. The UE may include the temporary ID in all RRC connection establishment during a subsequent initial access to enable the RAN to route NAS signaling between the UE and an appropriate AMF device.

Modification of Set of Network Slices for UE

A set of network slices for the UE may be changed at any time while the UE is registered with a network and may be initiated by the network or by the UE, under specific conditions as described below.

The network, based on local polices, subscription changes, and/or UE mobility, may change a set of allowed network slice(s) to which the UE is registered. The network may perform such a change during a registration procedure or trigger a notification toward the UE of the change of the network slices supported using a RM procedure (capable of triggering the registration procedure). The network provides the UE with new allowed NSSAI and a TAI list.

Details of the RM procedure used to notify the UE of the change of supported NSSAI may need to be defined.

To change a set of S-NSSAI being used, the UE may need to initiate the registration procedure.

A change (whether the UE or the network is initiated) of S-NSSAI to which the UE is registered may, subject to operator policy, lead to a change of the AMF device.

Reallocation of AMF Device Due to Network Slice Support

During a registration procedure in a PLMN, if the network determines that the UE needs to be served by a different AMF device based on network slice aspects, the AMF device that first receives a registration request may need to redirect the registration request to another AMF device through the RAN or through direct signaling between an initial AMF device and a target AMF device. The redirection message sent by the AMF device through the RAN may include information for selection of a new AMF device to serve the UE.

For a UE that is already registered, the system may support a redirection initiated by the network of the UE from its serving AFM device to the target AMF device due to network slice considerations. The operator policy may determine whether redirection between the AMF devices is allowed.

Establishing PDU Session in Required Network Slice Instance

The establishment of a PDU session in a network slice to a DN may allow data transmission in the network slice. The DN may be connected to S-NSSAI and DNN.

The network operator may provide the UE with a network slice selection policy (NSSP). The NSSAP may include at least one NSSP rule that associate an application with S-NSSAI. The NSSAP may include a default rule that matches all applications to S-NSSAI. When a UE application associated with specific S-NSSAI requests data transmission,

if the UE has one or more PDU sessions established corresponding to the specific S-NSSAI, the UE may route user data of the application in one of the PDU sessions unless other conditions in the UE prohibit the use of the PDU sessions. If the application provides the DNN, the UE may consider the DNN to determine which PDU session to the UE. If the UE does not have a PDU session established with the specific S-NSSAI, the UE may request a new PDU session corresponding to the S-NSSAI and with the DNN that may be provided by the application. For the RAN to select a proper resource for supporting network slicing in the RAN, the RAN needs to be aware of the network slices used by the UE.

The AMF device may select an SMF device in a network slice instance based on S-NSSAI, DNN, and other information, for example, UE subscription and other operator policies, when the UE triggers establishment of a PDU session. The selected SMF device may establish the PDU session based on S-NSSAI and DNN.

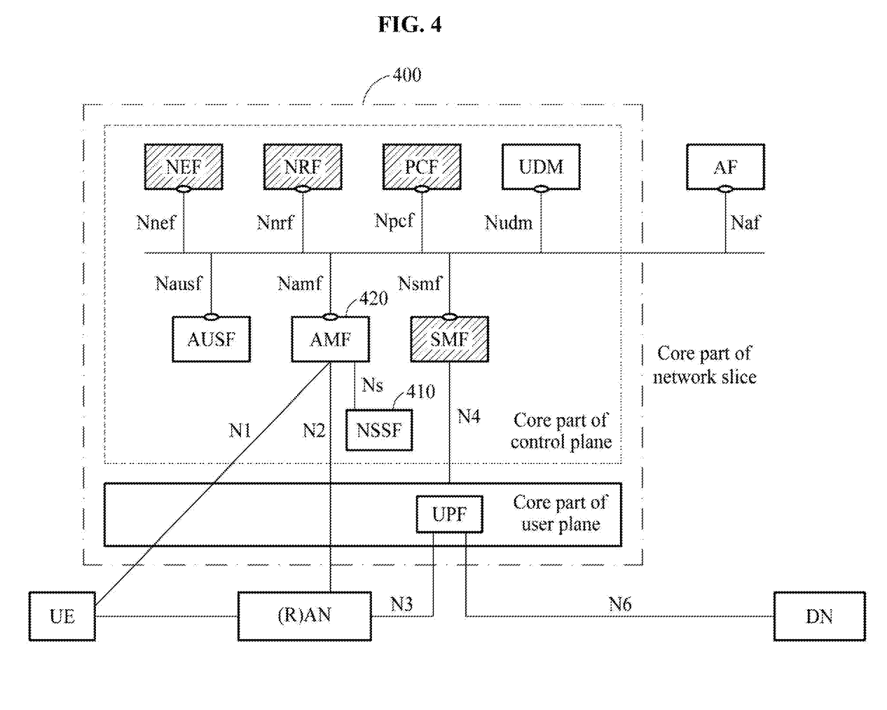

FIG. 4 illustrates a reference architecture for network slicing according to an example embodiment.

FIG. 4 illustrates a core part 400 of a network slice in the reference architecture according to an example embodiment.

In the case of network slicing, a control plane of the core part 400 of the network slice may include two parts, for example, a common control part and a slice-specific part. Network functions within the common control part may be shared by multiple slice instances, whereas network functions within the slice-specific part may be dedicated to a specific target slice instance.

The reference architecture of FIG. 4 may be a network slicing non-roaming service-based architecture. Due to network slicing, a network slice selection function (NSSF) 410 corresponding to an additional network function may be added to the architecture that is specific to a network slicing deployment to support a network slice selection. More details on the functionality of the NSSF 410 will be described below.

A control plane network function that has a darker shadow may be a candidate to reside in the common control part or the slice-specific part. A control plane network function that does not have the darker shadow may be included in only the common control part. A method of including the control plane network function having the darker shadow in the common control part or the slice-specific part depending on a target network service supported by a network slice instance may follow a decision of an operator.

Here, a network function may be implemented either as a network element on dedicated hardware or as a software instance running on dedicated hardware, or may be implemented as a virtualized function instantiated on an appropriate platform, for example, on a cloud infrastructure.

An access and mobility management function (AMF) 420 may include the following functions. A portion of or all of the functions of the AMF 420 may be supported by a single instance of the AMF 420.

Termination of RAN CP interface (N2)

Termination of NAS (N1), NAS ciphering and integrity protection

Registration management

Connection management

Reachability management

Mobility management

Lawful intercept (for AMF 420 events and interface to LI system)

Transparent proxy for routing SM messages

Access authentication

Access authorization

Security anchor function (SEA). The SEA may interact with an authentication server function (AUSF) and a UE, and may receive an intermediate key that is set as a result of a UE authentication process. In the case of universal subscriber identify module (USIM)-based authentication, the AMF 420 may retrieve security materials from the AUSF.

Security context management (SCM). The SCM may receive, from the SEA, a key used to derive an access network specific key.

Here, regardless of the number of network functions, a single non-access stratum (NAS) interface instance is present per radio access network (RAN) between the UE and a control network (CN), and terminated at one of network functions that implement at least NAS security and mobility management.

Once network slicing is deployed, the AMF 420 may interact with the NSSF 410 over a network slice interface and a network slice instance may be selected. The network slice instance selection (NSI selection) will be further described below.

Here, network slicing technology may indicate technology capable of applying network isolation and customization attributes to a mobile communication core network architecture by grouping and thereby providing network resources and network functions into a single independent slice based on a service. The network slicing technology, as a new concept of a 5G core network not used in the existing mobile communication network technology, may be technology for grouping and thereby providing network resources and network functions required for a service requested from a mobile terminal into a single independent slice.

In this manner, each network provider may independently allocate a network resource specified for each service and user, and may secure the expandability and reliability of service and network resource operation by achieving the network flexibility through software defined networking/network function virtualization (SDN/NFV) technology-based resource virtualization.

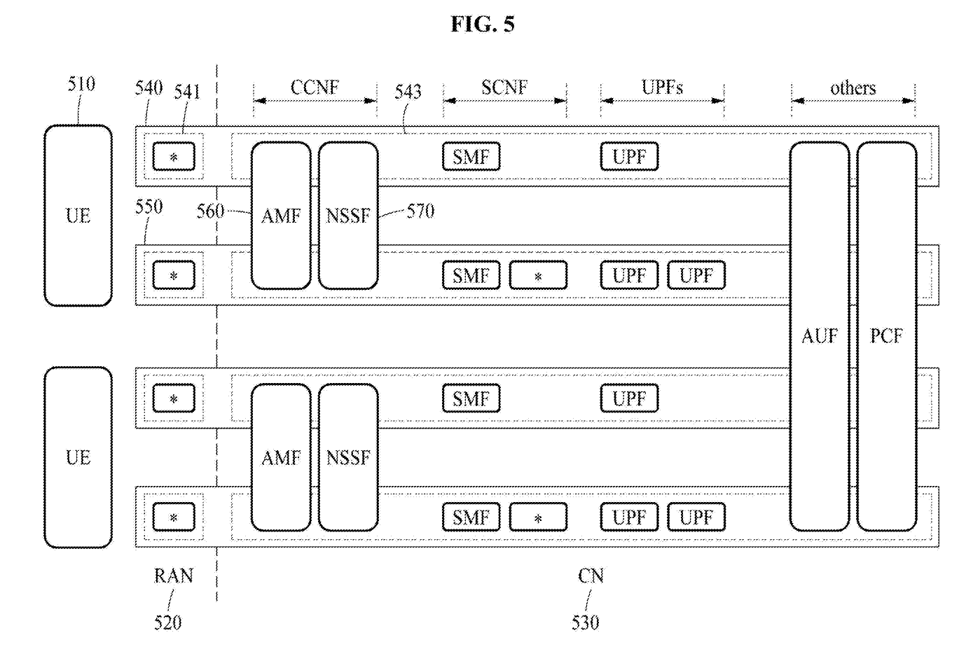

Hereinafter, the network slicing technology will be described with reference to FIG. 5.

FIG. 5 illustrates an architecture of a network slice according to an example embodiment.

Referring to FIG. 5, network slice instances are allocated to a UE.

The network slice may be a complete logical network that includes a set of network functions and corresponding resources required to provide a specific network capability and network characteristic. The network slice may be present on a radio access network (RAN) 520 and a core network (CN) 530. A network slice instance may be the instantiation of the network slice, that is, a deployed set of network functions that deliver intended network slice services according to a network slice template.

An AN may be common for multiple network slices. For example, the AN may be a non-3GPP access network or a 5G RAN.

The network slice may be configured to be different for each supported feature and network function optimization. An operator may deploy the plurality of network service instances that deliver exactly the same optimization and features, however, dedicated to different groups of UEs.

For example, referring to FIG. 5, a plurality of network slice instances 540 and 550 may be allocated to the UE 510. The network slice instances 540 and 550 may be defined on the RAN 520 and the CN 530. For example, the network slice instance 540 may include a RAN part 541 and a CN part 543. The CN part 543 may include a common control network function (CCNF), a slice-specific control network function (SCNF), user plane functions (UPFs), and others.

Each network slice instance may include at least one network function instance for providing a network service required for a corresponding network slice instance. For example, the network slice instance 540 may be for a multimedia service and the network slice instance 550 may be for an Internet of Things (IoT) service.

The UE 510 may simultaneously access the plurality of network slice instances 540 and 550 through a single RAN 520. In this case, the network slice instances 540 and 550 may share a portion of control plane functions, for example, an AMF 560 and an NSSF 570. A control plane function shared by the plurality of network slice instances 540 and 550 allocated to the same UE 510 may be referred to as the CCNF.

For example, the UE 510 may use only a single AMF 560. That is, a single UE 510 may not be allowed to use two or more AMFs. Conversely, a single AMF 560 may be allocated to one or more UEs. FIG. 5 illustrates a case in which a single AMF 560 is allocated to a single UE 510 as an example.

The AMF 560 and the NSSF 570 included in the CCNF may be shared between the plurality of network slice instances 540 and 550 through NF sharing.

Also, an authentication function (AUF) and a policy control function (PCF) may be shared between one or more network slice instances based on an operator's policy through NF sharing.

Similar to the AMF 560, the NSSF 570 is a function included in the CCNF, and used to select a network slice instance corresponding to the UE 510.

The NSSF 570 may be a network function that has knowledge and overview of an NSI topology for a given public land mobile network (PLMN) (for example, recognizing the availability of a set of active network slice instance(s) corresponding to registration areas and for which entry point, that is, the AMF 560, that is accessible to a specific network slice instance). Also, the NSSF 570 may support a slice-level service mapping for given single-network slice selection assistance information (S-NSSAI) to select a target network slice instance based on a serving mobile virtual network operator (MVNO), a service or an over the top (OTT) provider, a UE location, a time window, and the like. Here, the target network slice instance may be selected from a pool of network slice instances for specific S-NSSAI for load balancing and redundancy.

The NSSF 570 may enforce operator configured slice-level control rules. For example, to provide mission-critical services, such as an autonomous driving or a remote industrial robot control, a network slice instance that guarantees low-latency access needs to be acquired.

The NSSF 570 may support a statistic collection for a slice selection for a management system of the serving PLMN.

The following parameters may be used to perform communication with the AMF 560 based on the aforementioned understanding about the NSSF 570.

An input parameter of the NSSF 570 may include accepted S-NSSAI. Additionally, depending on cases, at least one of a previous related NSI list of the UE 510 and a serving registration area of the UE 510 may be further considered as the input parameter of the NSSF 570.

An output parameter of the NSSF 570 may include information, for example, an NSI ID, about a selected new serving network slice instance corresponding to the accepted S-NSSAI. Additionally, depending on cases, at least one of a fully qualified domain name (FQDN) or an IP address of a selected new serving AMF and an FQDN or an IP address of a selected serving NF repository function (NRF) for a selected network slice instance may be further considered as the output parameter of the NSSF 570.

In the case of network sharing, each PLMN may include its own provisioned network slice instance and corresponding NRF to support NF discovery and selection within a network slice instance. Also, in addition to a type of a network function as the input parameter, a logical network identifier may be provided to the NRF for the NF discovery and selection so that the NRF may support a network function discovery and selection operation regardless of whether network slicing is present. In the case of network slicing, the logical network identifier indicates an NSI ID and otherwise, the logical network identifier indicates a serving PLMN.

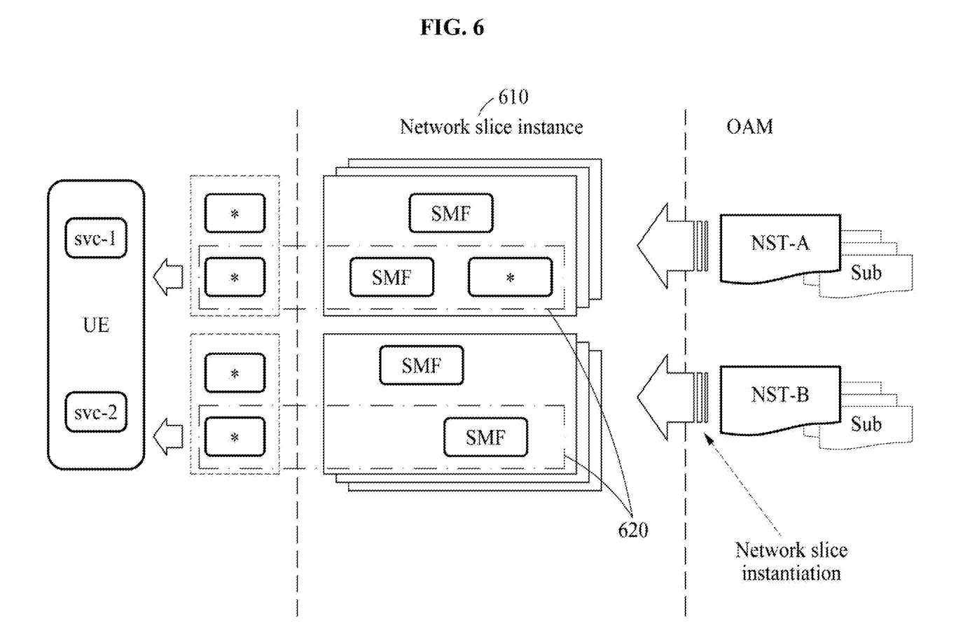

FIG. 6 illustrates an example of a network slice instance and a service instance according to an example embodiment.

FIG. 6 illustrates a network slice instance 610 and a service instance 620 according to an example embodiment.

At least one network slice instance 610 may be defined in a network system. One of the at least one network slice instance 610 may be selected to provide a service requested from a UE. Details on an NSI selection will be described below.

The network slice instance 610 may be a set of network function instances ready to support a network service requested from the UE. At least one network function instance may provide the same network function, for example, a session management function (SMF), within the network slice instance 610. When a plurality of network function instances provides the same network function within the same network slice instance 610, a single network function instance may be selected from among the plurality of network function instances. Details on an NFI selection will be described below.

A single network slice instance 610 may be allocated to at least one UE and may also be allocated to at least one service. The network slice instance 610 may correspond to a resource group per service of an operator.

The service instance 620 may be a set of serving network function instances that support a service requested from the UE. The service instance 620 may include each network function required for a corresponding service. The service instance 620 may indicate a network slice instance substantially allocated to the UE.

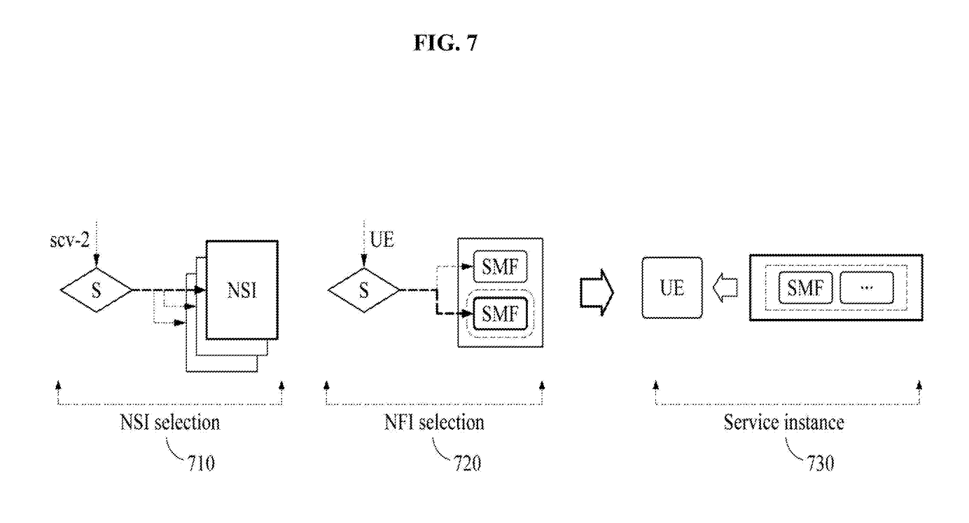

FIG. 7 illustrates an example of configuring a service instance according to an example embodiment.

A process of configuring a service instance 730 through an NSI selection 710 and an NFI selection 720 according to an example embodiment will be described with reference to FIG. 7.

In the NSI selection 710, a single network slice instance may be selected from among a plurality of network slice instances defined in a network system. Here, the network slice instance may be selected based on NSSAI. Additionally, the network slice instance may be selected by further using a network slice instance previously allocated to a UE and a serving registration area of the UE. An available NSI ID may be output as a selection result. Additionally, at least one of IP addresses of a new AMF and a serving NRF for the selected network slice instance may be further output. It will be further described.

In the NFI selection 720, a single network function instance may be selected from among a plurality of network function instances within the selected network slice instance. Here, the network function instance may be selected based on a logical network identifier and a type of a network function. The logical network identifier indicates an NSI ID in the case of network slicing, and otherwise, indicates a serving PLMN. The type of the network function indicates a role of a corresponding network function instance and may include, for example, an AMF, an NSSF, an SMF, a UPF, an AUF, a PCF, and the like. A single network function instance may be selected per type of a network function required to provide the network service requested from the UE.

For example, referring to FIG. 7, a plurality of SMFs may be present within a selected network slice instance. Even using the logical network identifier, that is, the selected NSI ID, and the type of the network function, that is, the SMF, a single network function instance may not be selected. In this case, the operator's policy may be additionally considered. The operator's policy refers to a policy set by a network operator and may include, for example, load balancing, resource optimization, energy efficiency, traffic optimization, and the like.

For example, an SMF having the relatively small number of currently using UEs may be selected from two SMFs. Alternatively, an SMF having a relatively excellent QoS may be selected from the two SMFs. Alternatively, an SMF corresponding to a fee plan, for example, a basic fee plan and a premium fee plan, of a corresponding UE may be selected from the two SMFs. Alternatively, an SMF corresponding to a serving registration area of the corresponding UE may be selected from the two SMFs. Depending on cases, a network function instance may be selected by further using at least one of the aforementioned various criteria.

The service instance 730 may indicate a selected network slice instance that includes the selected network function instance. The service instance 730 may indicate a network slice instance capable of completely providing the network service requested from the UE.

Hereinafter, the NSI selection 710 and the NFI selection 720 will be further described. The NSI selection 710 may be performed through a UE registration procedure and a PDU session establishment procedure. The NFI selection 720 may be performed through the PDU session establishment procedure.

If a network system deploys network slicing, at least one network slice instance may be selected based on NSSAI provided from the UE. The NSSAI is a set of S-NSSAI. Each piece of S-NSSAI may be used to select a specific network slice instance. In addition, UE capabilities and UE subscription data may be used to select a network slice instance.

S-NSSAI may include a slice/service type (SST) and a slice differentiator (SD). Here, the SST refers to an expected network behaviour in terms of features and services. The SD refers to optional information that complements the SST and may differentiate a plurality of network slice instances that satisfy the SST.

The UE subscription data may include information about a network slice instance that the UE is allowed to access. Information within the UE subscription data may include a plurality of pieces of S-NSSAI that the UE is allowed to use.

Also, the UE subscription data may include information regarding whether corresponding S-NSSAI is default S-NSSAI. Here, the default S-NSSAI may indicate a network slice instance that the UE is to use to attach to the network system. When the UE makes an initial registration to the network system without providing any NSSAI in a registration request, a CN needs to use default NSSAI including S-NSSAI values stored in the UE subscription data with a flag indicating that they are to be considered as default, in order to determine a default initial network slice instance to serve the UE. Also, the UE subscription data may include a data network name (DNN) value for S-NSSAI.

A CN part of a network slice instance that serves the UE may be selected by the CN, not by a RAN. The UE may simultaneously access a plurality of network slice instances through a single RAN. In this case, the network slice instances simultaneously accessed by the UE may share a portion of control plane functions that include an AMF in the CN.

An AMF selection for a set of network slice instances for the UE may be triggered by a first contacted AMF in a registration procedure, which may lead to change of the AMF. Once a target network slice instance is selected and a session management (SM) message for establishing a PDU session is received from the UE, a subsequent SMF network function discover and selection may be initiated by the AMF. An NRF may be used to perform the above selection tasks.

The PDU session may belong to a specific network slice instance. Although different network slice instances may not share the PDU session, the different network slice instances may include slice-specific PDU sessions to the same DNN.

The S-NSSAI may include standard values or PLMN-specific values. The plurality of pieces of S-NSSAI with PLMN-specific values may be associated with a PLMN ID of a PLMN that assigns the S-NSSAI in the UE. A single piece of S-NSSAI may not be used by the UE in access stratum procedures in any PLMN other than the one with which the S-NSSAI is associated.

The NSSAI may be used to select the AMF and a set of network slice instances, whereas the S-NSSAI may be used to select a specific network slice instance. Each piece of S-NSSAI included in the NSSAI may include (a) an SST or (b) the SST and an SD.

The UE may store configured and/or accepted NSSAI per PLMN. The configured NSSAI may be NSSAI configured in the UE by a home PLMN (HPLMN) to be used at the PLMN when no PLMN-specific accepted NSSAI is stored.

The accepted NSSAI refers to NSSAI provided from the PLMN to the UE, and the UE needs to use the accepted NSSAI after the PLMN successfully registers the UE. A registration accept message may include the accepted NSSAI. The accepted NSSAI may be updated through a subsequent registration procedure.

If configured or accepted NSSAI about a PLMN that the UE accesses is provided to the UE, the UE may provide the NSSAI in radio resource control (RRC) connection establishment and non-access stratum (NAS). The RAN may route an initial access to the AMF using the provided NSSAI.

If the UE does not receive any accepted NSSAI about the PLMN that the UE accesses and is provided with configured NSSAI, the UE may provide the configured NSSAI in the RRC connection establishment and NAS to the RAN. The RAN may use the NSSAI to route the initial access to the AMF. Alternatively, if the UE is not provided with any accepted NSSAI or configured NSSAI about the PLMN that the UE accesses, the UE may not provide the NSSAI in the RRC connection establishment and NAS and the RAN may send NAS signaling to a default AMF.

A network operator may provide a network slice selection policy (NSSP) to the UE. The NSSP may include one or more NSSP rules each that associates an application with specific S-NSSAI. The NSSP may include a default rule that matches all applications and includes default S-NSSAI. The UE may use the NSSP to associate a UE application with S-NSSAI.

When a UE application associated with specific S-NSSAI requests data transmission, and in this instance, if the UE includes one or more PDU sessions established with the specific S-NSSAI and if the other conditions of the UE do not prohibit the use of PUD sessions, the UE may route user data of the application in one of the PDU sessions. If the application provides a DNN, the UE may determine a PDU session to use based on the DNN.

When the UE application associated with the specific S-NSSAI requests the data transmission, and in this instance, if the UE does not include a PDU session established with the specific S-NSSAI, the UE may request a new PDU session with the S-NSSAI and the DNN that may be provided by the application.

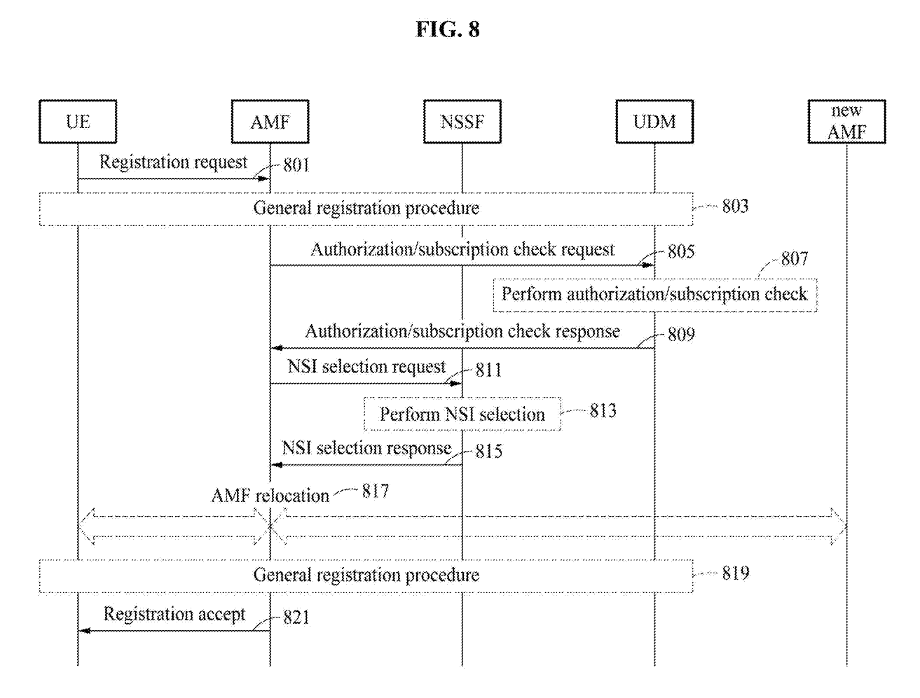

FIG. 8 illustrates an example of selecting an NSI in a UE registration procedure according to an example embodiment.

A communication method performed by a UE and a communication apparatus will be described with reference to FIG. 8. In FIG. 8, the UE refers to the user equipment and an AMF, a NSSF, a UDM, and a new AMF may indicate network function instances included in the communication apparatus.

Referring to FIG. 8, in operation 801, the UE sends a registration request to the AMF. The UE may send the registration request to the AMF with one of default NSSAI, configured NSSAI, and accepted NSSAI through a RAN. Here, the AMF may be an initial AMF.

In operation 803, a general registration procedure may be performed. The general registration procedure may be performed.

In operation 805, the AMF may send an authorization/subscription check request to the UDM with the NSSAI.

In operation 807, the UDM may check whether the UE is allowed to use a requested network slice instance (NSI) based on the NSSAI.

In operation 809, the UDM may send an authorization/subscription check response to the AMF with the accepted NSSAI. That is, the AMF may acquire the accepted NSSAI from the UDM and accordingly, may determine potential accepted S-NSSAI.

In operation 811, the AMF may send an NSI selection request to the NSSF with the accepted NSSAI.

In operation 813, the NSSF may determine the availability of the requested NSI based on the accepted NSSAI. If the NSSF detects a more appropriate AMF capable of providing the selected NSI than a current AMF, that is, the AMF that sends the NSI selection request to the NSSF, the NSSF may provide information about the new AMF to the current AMF.

In operation 815, the NSSF may forward information about the selected NSI to the AMF as an NSI selection response. Also, the NSSF may also forward information about the new AMF to the AMF as the NSI selection response.

If the current AMF determines to relocate a serving AMF for the UE in operation 817, the AMF may trigger an AMF relocation procedure based information about the new AMF provided from the NSSF.

In operation 819, the general registration procedure may be performed.

In operation 821, the AMF may send a registration accept message to the UE with the accepted NSSAI.

That is, in the UE registration procedure, the AMF may acquire the accepted NSSAI from the UDM and may determine a set of potential accepted S-NSSAI. The availability of a network slice instance according to the serving registration area of the UE may be determined by verifying the set of potential accepted S-NSSAI through the NSSF.

The accepted NSSAI may be a result of validating the registration request from the UE in terms of the authorization/subscription check that is performed through consultation with the UDM that provides a list of authorized NSSAI, and the availability of the network slice instance that is performed through consultation with the NSSF that is provided by OA&M. Also, the accepted NSSAI may be altered based on a result of the NSI availability check at the NSSF as well as the subscription check.

After an initial slice selection or upon a successful attachment registration, the UE may be provided with a temporary ID that is used by the UE in an RRC connection establishment of a subsequent initial access so that the RAN may route a NAS message to an appropriate AMF as long as the temporary ID is valid. Also, the serving PLMN may return accepted NSSAI that includes a PLMN ID of the serving PLMN. The accepted NSSAI may include S-NSSAI values of network slice instances that are accepted by the PLMN for the UE to use. Here, it is assumed that a RAN and core slicing-related configuration does not change within a registration area of the UE.

For enabling routing of NAS signaling to correct CN functions, the UE may include NSSAI stored for the PLMN and a complete temporary ID in an RRC. If the RAN is aware of and capable of reaching the AMF associated with the temporary ID, the RAN may forward the request to this AMF. Otherwise, the RAN may select an appropriate AMF based on the NSSAI provided from the UE, and may forward the request to the selected AMF. If the RAN is incapable of selecting the AMF based on the accepted NSSAI, the request may be sent to a default AMF.

The UE may need to include, in a PDU session establishment request NAS message, S-NSSAI that enables selection of an SMF with a DNN of a data network for a PDU session.

The RAN needs to be aware of a network slice used by the UE so that the RAN may select an appropriate resource for supporting network slicing in the RAN.

The UE may cause a network to change a set of slice instances the UE is using by submitting a new value of NSSAI in a registration request procedure. A final decision of a set of network slices allocated to the UE may be made by the network.

The network system may change a set of network slice instances that are being used by the UE by providing the UE with a notification of accepted NSSAI change based on local policies, subscription changes, and/or UE mobility. This may trigger a UE-initiated registration procedure that includes, in RRC and NAS signaling, a value of new accepted NSSAI provided from the network.

Changing a set of network slice instances initiated by the UE or the network may lead to changing an AMF based on an operator's policy. Changing a set of network slice instances accessible by the UE may cause termination of an ongoing PDU session with an original set of network slices if the network slice instances are not longer used. Here, some slices may be still retained potentially, that is, available.

During the initial registration procedure, when the network system determines that the UE needs to be served by another AMF, the AMF having received the initial registration request needs to redirect the initial registration request to a target AMF through the RAN or through direct signaling between the initial AMF and the target AMF. A redirection message sent from the AMF through the RAN may include information about the target AMF to serve the UE.

With respect to a UE that is already registered, the network system needs to support redirection of a UE from a serving AMF to a target AMF. The operator policy may be used to determine whether redirection between AMFs is allowed.

When the network system determines to redirect the UE due to the NSSAI change, the network system may send, to the UE, (a) updated/new NSSAI using a registration update required procedure and (b) an indication for the UE to initiate a registration update procedure with the updated/new NSSAI.

The AMF may select an SMF in a network slice instance based on S-NSSAI, a DNN, and other information, for example, UE subscription and local operator policies. The selected SMF may set a PDU session based on S-NSSAI and the DNN.

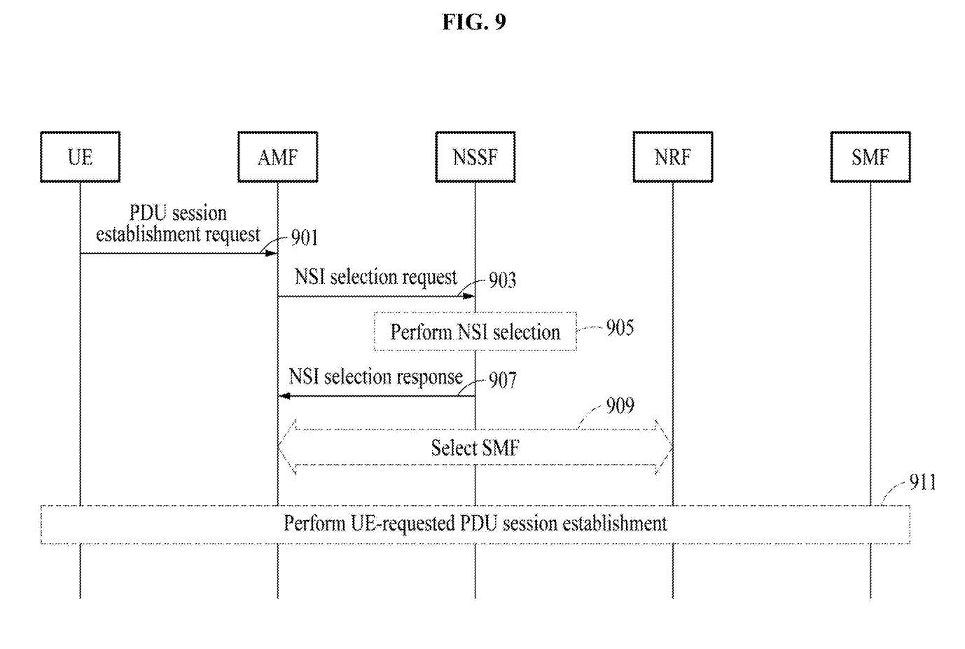

FIG. 9 illustrates an example of selecting a network slice instance and a network function instance in a PDU session establishment procedure according to an example embodiment.

A communication method performed by a user equipment and a communication apparatus according to an example embodiment will be described with reference to FIG. 9. In FIG. 9, the UE refers to the user equipment and an AMF, an NSSF, an NRF, and an SMF may indicate network function instances included in the communication apparatus. In operation 901, the UE may send a PDU session establishment request to the AMF with S-NSSAI through a RAN.

In operation 903, the AMF may send an NSI selection request to the NSSF with accepted S-NSSAI and an active network slice instance (NSI) accessed by the UE.

In operation 905, the NSSF may select a network slice instance corresponding to a serving registration area of the UE.

In operation 907, the NSSF may respond to the AMF for a selected serving network serving instance (NSI) and a serving NRF corresponding to the selected NSI.

In operation 909, the AMF may select an SMF through interaction with the serving NRF corresponding to the selected NSI.

In operation 911, a UE-request PDU session establishment may be performed.

That is, when performing the PDU session establishment, the AMF may verify a set of potential accepted S-NSSAI through the NSSF to determine the availability of a network service instance according to the serving registration area of the UE. Also, the AMF may provide active NSI information accessed by the UE to the NSSF. The NSSF may provide information about the selected NSI and the serving NRF corresponding to the selected NSI to the AMF as a response.

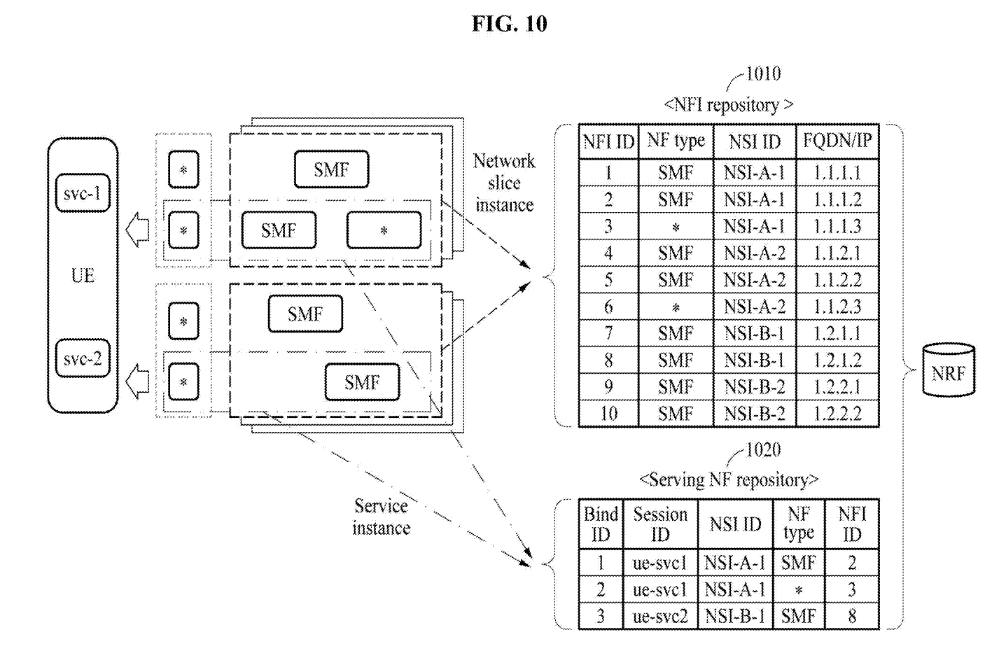

FIG. 10 illustrates an example of a repository according to an example embodiment.

FIG. 10 illustrates an NFI repository 1010 and a serving NF repository 1020.

An NRF may manage the NFI repository 1010 and the serving NF repository 1020. The NFI repository 1010 may include information about network function instances defined in a network system. For example, the NFI repository 1010 may include an NFI ID, an NF type, an NSI ID, and an FQDN/IP. The NFI ID denotes an instance of a corresponding network function instance, and the NSI ID denotes an ID of a network slice instance that includes the corresponding network function instance.

The NFI repository 1010 may be updated by an Operations, Administration and Management (OAM). In detail, NSI orchestration included in the OAM may perform a network slice (NS) instantiation and a network slice instance (NSI) update and termination. Also, NFI orchestration included in the OAM may perform a network function (NF) instantiation, an NFI update and termination, and an NFI scaling and migration.

An NFI selection may be performed based on information included in the NFI repository 1010. In response to an occurrence of the NFI selection, the NRF may store information about the selected NFI in the serving NF repository 1020. That is, the serving NF repository 1020 may include information about the serving NFI selected for the UE. An NFI included in the serving NF repository 1020 may constitute a service instance.

The NRF may support a service discovery function. In response to an NF discovery request received from a network function instance, the NRF may provide information about the discovered network function instance to the network slice instance that requests NF discovery.

In addition to a network function type, a logical network identifier may be provided to the NRF so that the NRF may support a network function selection and discovery operation regardless of whether network slicing is present. In the case of network slicing, the logical network identifier indicates an NSI ID and otherwise, the logical network identifier indicates a serving PLMN.

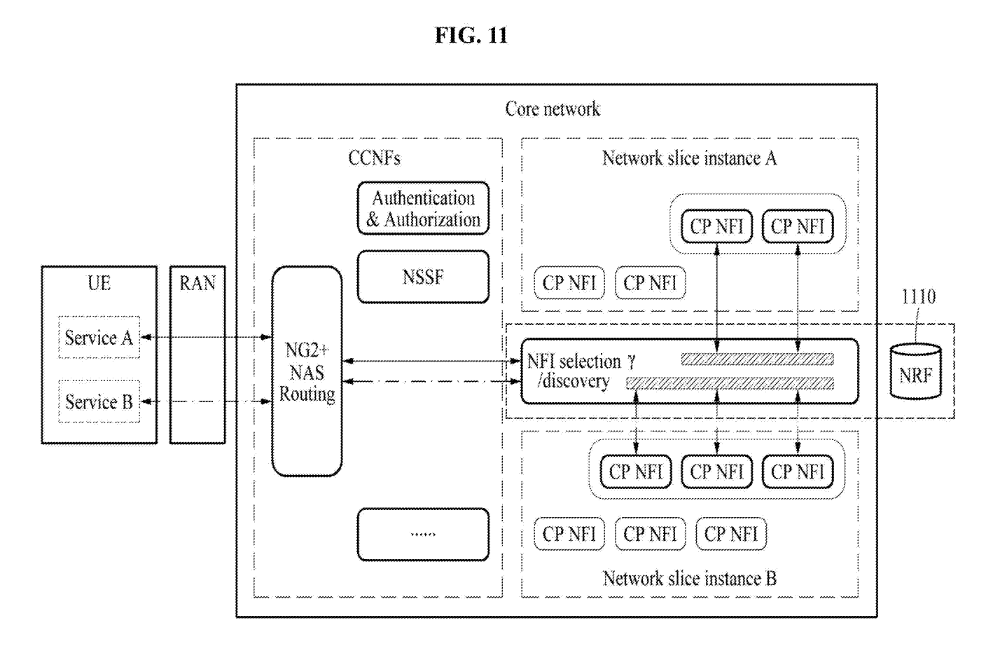

FIG. 11 illustrates an NRF 1110 to perform an NFI selection/discovery function according to an example embodiment.

Referring to FIG. 11, the NRF 1110 may manage a selection result of a network function instance, and may perform discovery for the selected network function instance in response to a request from the network function instance.

A plurality of instances for a network function may be provided within the network slice instance for redundancy, expandability, and the like. That is, a plurality of instances for the same network function may have different QoS attributes, for example, capability, performance, and the like. An appropriate network function instance may be selected from the network slice instance based on QoS attributes of network function instances. Alternatively, a network function instance may be reselected to meet a specific QoS attribute.

This NFI selection may be based on the following rules.

A network slice instance may include a plurality of network function instances for a specific service with network capabilities. A network slice instance per requested UE service may be selected based on “network slice selection assistance information” (NSSAI). Various network function instances may be provided for capability, duplication, expandability, and the like, within the network slice instance. A set of network function instances may be selected per UE service request for binding. An NFI selection may be performed according to a policy of the network operator, for example, energy efficiency, load balancing, resource optimization, and the like. Binding information of the selected network function instance may be additionally provided to the NRF 1110. For roaming, a set of network function instances may be updated by reselecting the network function instance or by changing QoS attributes of the network function instance, the policy of the network operator, roaming, and the like.

An NSSF may select an appropriate network slice instance based on the NSSAI. In detail, the NSSF may determine a target network slice instance classified into a service type requested from the UE and may select a network slice instance based on a variety of UE and network-provided NSSAI. For example, the NSSAI may include UE subscription data, the policy of the network operator, and the like.

The NRF 1110 may select an appropriate network function instance based on resource operational policies of the network operator, for example, load balancing, resource optimization, and the like. In detail, the NRF 1110 may identify a network function (NF) or an NF type of a given network slice instance, may determine a single instance from among a plurality of instances of each NF or NF type within the given network slice instance, and may store binding information of the selected network function instances in a serving NF repository of the NRF 1110.

NRF

According to an example embodiment, the NF repository function (NRF) may support the following functionality:

may support a service discovery function, receive an NF discovery request from an NF instance, and may provide information of the discovered NF instance to an NF instance

Network Function Discovery and Selection

The NF discovery enables one NF to discover a specific target NF type.

Unless expected NF information is locally configured on a requester NF, for example, the expected NF may be in the same PLMN as the NF discovery is implemented through the NRF. The NRF is a logical function used to support the functionality of NF discovery.

To prevent access to a requested type NF and related NF stored in the requester NF, the requester NF may initiate the NF discovery by providing the type of the NF (e.g., SMF and PCF) and other service parameters. The target NF may be discovered by slicing relevant information.

The NRF may provide an IP address or an FQDN of the NF instance to the requester NF to select a target NF instance. Based on this information, the requester NF may select a single NF instance.

For NF discovery through PLMNs, the requester NF may provide the NRF with a PLMN ID of the target NF. The NRF in the local PLMN may interact with the NRF in the target PLMN and may retrieve an IP address or an FQDN of the target NF instance.

NRF Service

“NF Discovery” Service

Service description: provides an IP address or an FQDN of an expected NF instance to the requester NF.

Input: NF type of a target NF, an NF type of the requester NF, PLMN ID of a PLMN the target NF belongs to, service related information

Output: Set of target NF instances

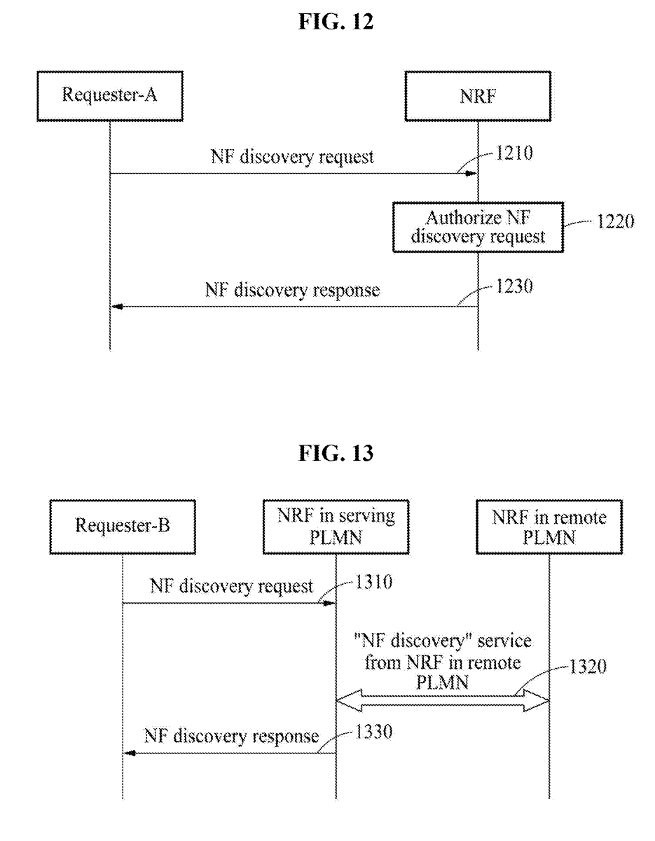

FIG. 12 illustrates an example of a service procedure according to an example embodiment.

Referring to FIG. 12, in operation 1210, a requester-A may need to discover an expected NF instance(s). For example, an AMF device may request to discover an SMF instance(s) in the same PLMN. The requester-A sends an NF discovery request to NRF in the same PLMN, including an NF type of the expected NF instance, an NF type of the requester NF, network slice related information (optional), and other service related parameters.

In operation 1220, the NRF may authorize the NF discovery request. Based on a profile of the expected NF and the type of the requester NF, the NRF may determine whether the requester NF is allowed to discover the expected NF instance(s). If the expected NF instance(s) are deployed in one network slice, the NRF may authorize the discovery request according to the discovery configuration of the network slice. For example, the expected NF instance(s) may be only discoverable by the NF in the same network slice.

In operation 1230, if allowed, the NRF may determine the discovered NF instance and provide information on a set of discovered NF instance(s) to the requester through an NF discovery response message. Information on the discovered NF instance(s) may include an FQDN or an IP address of the expected NF instance.

In the case that the requester needs to discover the NF in another PLMN, the NRF providing the PLMN may request an “NF discovery” service from the NRF in a remote PLMN. A procedure according to an example embodiment will be described with reference to FIG. 13.

Referring to FIG. 13, in operation 1310, a requester-B NF may need to discover an NF instance in a remote PLMN. For example, the AMF device may request to discover an SMF instance in the remote PLMN. The requester may send an NF discovery request to an NRF. An NF type of the expected NF and a remote PLMN ID may be included in the NF discovery request.

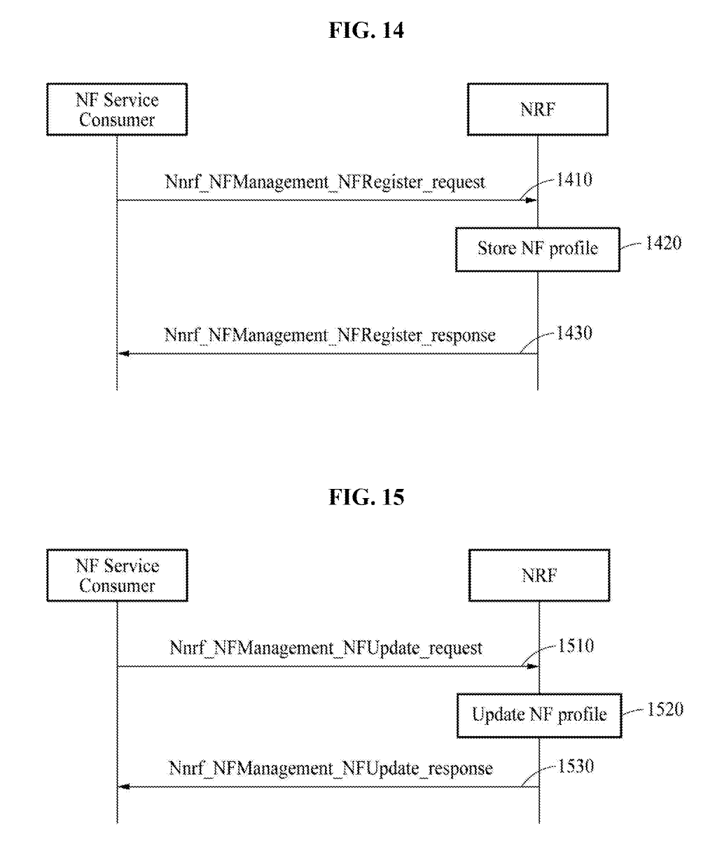

In operation 1320, the NRF providing a PLMN service may identify the NRF in the remote PLMN based on the remote PLMN ID, and may request the “NF discovery” service from the NRF in the remote PLMN according to the procedure of FIG. 14 to obtain the expected NF instance (s) deployed in the remote PLMN. As the NRF in the serving PLMN triggers the “NF discovery” on behalf of the requester-B NF, the NRF in the serving PLMN may not replace information on the service requester NF, i.e., the requester-B NF, in the discovery request message it sends to the NRF in the remote PLMN.

In operation 1330, the NRF in the service PLMN may provide information on a set of discovered NF instance(s) in an NF discovery response message.

FIG. 14 illustrates an example of an NF service registration procedure according to an example embodiment.

Referring to FIG. 14, in operation 1410, an NF service consumer, for example, an AMF instance, may send an Nnrf_NFManagement_NFRegister_Request message, for example, an NF profile of NF service consumer, to NRF to inform the NRF of its NF profile when the NF service consumer becomes operative for the first time. The NF profile of the NF service consumer includes an NF type, FQDN or IP address of NF, names of supported services, endpoint information of instance(s) of each supported service, and other service parameters.

In the case of UDR, the Nnrf_NFManagement_NFRegister_Request message may include range(s) of SUPIs and/or the data set identifier(s) served by a UDR instance. Here, the NF profile of the NF service consumer interacting with the NRF may be configured by an OAM system.

In operation 1420, the NRF may store the NF profile of the NF service consumer and mark the NF service consumer available. Whether the NF profile sent by the NF service consumer to the NRF needs to be integrity protected by the NF service consumer and verified by the NRF is to be determined.

In operation 1430, the NRF may send an Nnrf_NFManagement_NFRegister_Response message acknowledging that NF registration is accepted.

FIG. 15 illustrates an example of an NF service update procedure according to an example embodiment.

Referring to FIG. 15, in operation 1510, an NF service consumer, for example, an AMF instance, may send an Nnrf_NFManagement_NFUpdate_Request message, for example, an updated NF profile of the NF service consumer, to NRF to inform the NRF of its updated NF profile (e.g., updated capacity) when, for example, triggered after a scaling operation. Here, the updated NF profile of the NF instance may be configured by an OAM system.

In operation 1520, the NRF may update the NF profile of the NF service consumer.

In operation 1530, the NRF may send an Nnrf_NFManagement_NFUpdate_Response message acknowledging that NF update is accepted.

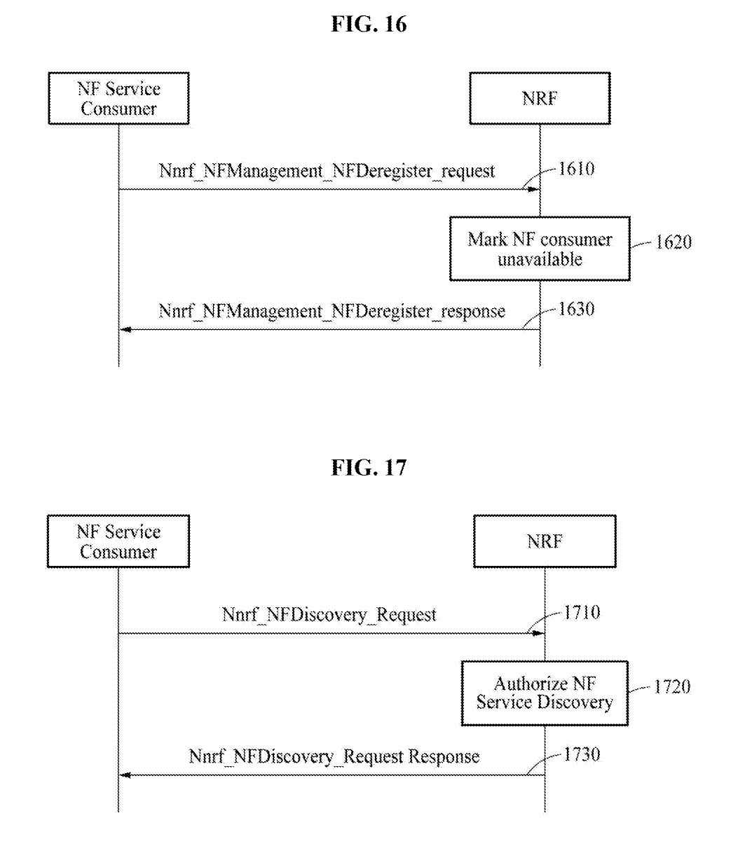

FIG. 16 illustrates an example of an NF service deregistration procedure according to an example embodiment.

Referring to FIG. 16, in operation 1610, an NF service consumer, for example, an AMF instance, may send an Nnrf_NFManagement_NFDeregister_Request message to NRF to inform the NRF of its unavailability when, for example, it is about to gracefully shut down or disconnect from the network.

In operation 1620, the NRF may mark the NF service consumer unavailable. The NRF may remove an NF profile of the NF service consumer according to NF management policy.

In operation 1630, the NRF may send an Nnrf_NFManagement_NFDeregister response message acknowledging that NF deregistration is accepted.

FIG. 17 illustrates an example of an NF/NF service discovery in the same PLMN according to an example embodiment.

Referring to FIG. 17, in operation 1710, an NF service consumer may intend to discover services available in a network based on a service name and a target NF type. The NF service consumer may invoke Nnrf_NFDiscovery_Request (e.g., expected NF service name, NF type of the expected NF instance, NF type of the NF consumer) from an appropriate configured NRF in the same PLMN. The parameter may include optionally SUPI, data set identifier(s), S-NSSAI, NSI ID if available, and other service related parameters.

Here, the use of NSI ID within a PLMN depends on a network deployment. The need for other service related parameters depends on the NF type of the expected NF instance(s). One or more NF service instances are registered in the NRF depends on NF implementation.

In operation 1720, the NRF may authorize the Nnrf_NFDiscovery_Request. Based on a profile of the expected NF/NF service and the type of the NF service consumer, the NRF may determine whether the NF service consumer is allowed to discover the expected NF instance(s). If the expected NF instance(s) or NF service instance(s) are deployed in a specific network slice, the NRF may authorize a discovery request according to the discovery configuration of the network slice. For example, the expected NF instance(s) may be only discoverable by the NF in the same network slice.

In operation 1730, if allowed, the NRF may determine the discovered NF instance(s) or NF service instance(s) and may provide information of a set of discovered NF instance(s) or NF service instance(s) to the NF service consumer via an Nnrf_NFDiscovery_Request Response message.

In the case that the target NF is UDR, if SUPI is used as an optional input parameter in the request, the NRF may provide the UDR instance(s) that matches the optional input SUPI. Otherwise, if SUPI is not provided in the request, the NRF may return all applicable UDR instance(s).

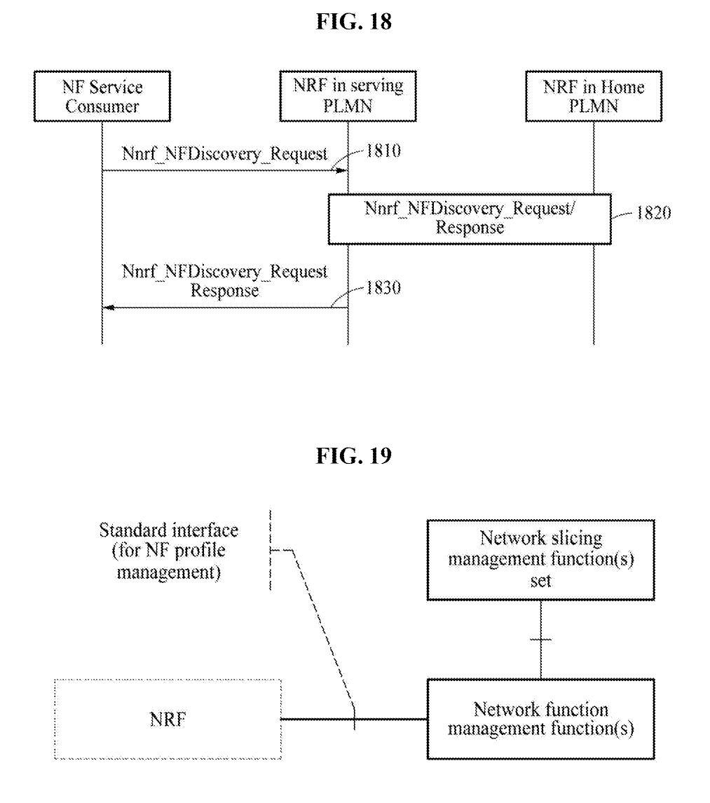

FIG. 18 illustrates an example of an NF/NF service discovery through PLMNs according to an example embodiment.

In the case that the NF service consumer intends to discover an NF/NF service in a home PLMN, an NRF in a serving PLMN needs to request “NF Discovery” service from the NRF in the home PLMN.

Referring to FIG. 18, in operation 1810, the NF service consumer may invoke Nnrf_NFDiscovery_Request (e.g., expected service name, NF type of the expected NF, home PLMN ID, serving PLMN ID, NF type of the NF service consumer). The request may also include optionally S-NSSAI, NSI ID if available, and other service related parameters.

Here, the use of NSI ID within a PLMN depends on a network deployment.

In operation 1820, an NRF in a serving PLMN may identify an NRF in a home PLMN (hNRF) based on a home PLMN ID, and may request an “NF Discovery” service from the NRF in the home PLMN according the procedure of FIG. 17 to acquire the expected NF instance(s) or NF service instance(s) deployed in the home PLMN. As the NRF in the serving PLMN triggers the “NF Discovery” on behalf of the NF service consumer, the NRF in the serving PLMN may not replace information of a service requester NF, i.e., NF consumer ID, in the Discovery Request message it sends to the hNRF.

The hNRF may further query an appropriate local NRF in the home PLMN based on input information received from the NRF of the serving PLMN. An FQDN or an IP address of the local NRF in the home PLMN may be configured in the hNRF or may need to be discovered based on the input information.

Here, the hNRF may discover an appropriate local NRF in the home PLMN through support from an NSSF in the home PLMN. Due to network topology hiding or network configuration, the home NRF may provide information of an IP address or the FQDN of a proxy function of the discovered NF/NF service to the serving NRF.

In operation 1830, the NRF in the serving PLMN may provide information, for example, FQDN, IP address, or endpoint addresses (i.e., URLs) of a set of the discovered NF or NF service instance(s) in the NF Discovery Response message.

<NRF Services>

The following Table 1 shows NRF services and service operations.

[Table 1]

TABLE 1

| | Service | Operation | |
|---|---|---|---|
| Service Name | Operations | Semantics | Example Consumer(s) |
| Nnrf_NFManagement | NFRegister | Request/Response | AMF, SMF, UDM, AUSF, |
| | | | NEF, PCF, SMSF, NSSF |
| | NFUpdate | Request/Response | AMF, SMF, UDM, AUSF, |
| | | | NEF, PCF, SMSF, NSSF |
| | NFDeregister | Request/Response | AMF, SMF, UDM, AUSF, |
| | | | NEF, PCF, SMSF, NSSF |
| | NFStatusSubscribe | Subscribe/Notify | AMF, SMF, PCF, NEF, |
| | | | NSSF, SMSF, AUSF |
| | NFStatusNotify | | AMF, SMF, PCF, NEF, |
| | | | NSSF, SMSF, AUSF |
| | NFStatusUnSubscribe | | AMF, SMF, PCF, NEF, |
| | | | NSSF, SMSF, AUSF |
| Nnrf_NFDiscovery | Request | Request/Response | AMF, SMF, PCF, NEF, |
| | | | NSSF, SMSF, AUSF |

Examples of Nnrf_NFManagement_NFRegister service operation follow as:

i) Service operation name: Nnrf_NFManagement_NFRegister.

ii) Description: registers the consumer NF in the NRF by providing the NF profile of the consumer NF to the NRF, and the NRF marks the consumer NF available.

iii) Inputs, required: NF profile of the NF consumer (NF type, NF ID, NF services).

iv) Inputs, optional: In the case that the consumer NF stores data sets(s) (e.g., UDR): range(s) of SUPIs, data set identifier(s)

v) Outputs, required: result indication

vi) Outputs, optional: none

Examples of Nnrf_NFManagement_NFUpdate service operation follow as:

i) Service operation name: Nnrf_NFManagement_NF Update.

ii) Description: provides the updated NF profile of NF consumer to the NRF.

iii) Inputs, required:

iv) Inputs, optional: NF profile of the NF consumer

v) Outputs, required: result indication

vi) Outputs, optional: none

Examples of Nnrf_NFManagement_NFDeregister service operation follow as:

i) Service operation name: Nnrf_NFManagement_NFDeregister

ii) Description: informs the unavailability of the NF consumer to the NRF.

iii) Inputs, required; NF instance ID, reason indication.

iv) Outputs, required: result indication

v) Outputs, optional: none

<Management Support of NRF>

The operator wants to maintain, to an up-to-date state, the NF profile (e.g., NF type, NF ID, NF services) of 5GC NF instances in the NRF instance that is used for NF instance and service discovery.

The NF profile that needs to be managed by the NRF is as follows:

i) NF instance ID, ii) NF type, iii) PLMN ID, iv) network slice related identifier(s), for example, S-NSSAI and NSI ID, v) fully qualified domain name (FQDN) or IP address of NF, vi) NF capacity information, vii) NF specific service authorization information, viii) names of supported services, ix) endpoint information of instance(s) of each supported service, and x) identification of stored data/information. The NF profile may be registered/updated/deregistered to the NRF by two different types of 3GPP entities:

i) The NF instance itself and ii) NF instance lifecycle management entity of 3GPP management system

The functional architecture and details of NF profile registration/update/deregistration by a 3GPP management system is described as follows:

i) NF profile registration: When a new 5GC NF instance is deployed, the 3GPP management system requests the NRF instance to add an NF profile of the new 5GC NF instance.

ii) NF profile update: When an NF profile of a 5GC NF instance is changed, the 3GPP management system requests the NRF instance to update the NF profile of the given 5GC NF instance.

iii) NF profile deregistration: When the 5GC NF instance is removed, the 3GPP management system requests the NRF instance to delete the NF profile of the given 5GC NF instance.

FIG. 19 illustrates an example of an NF profile management interface according to an example embodiment.

A management system may manage an NF profile using an interface between an NRF and a network function management function(s) (NFMF). The management system may include at least one of the NFMF and a network slicing management function(s) set (NSMFS).

<NRF>

An NF repository function (NRF) may support the following functionality:

i) may support a service discovery function, receive an NF discovery request from an NF instance, and provide the information of the discovered NF instances (be discovered) to the NF instance, and ii) may maintains NF profile of available NF instances and their supported services.

The NF profile of the NF instance maintained in the NRF may include the following information:

i) NF instance ID, ii) NF type, iii) PLMN ID, iv) network slice related identifier(s) (e.g., S-NSSAI and NSI ID), v) FQDN or IP address of NF, vi) NF capacity information, vii) NF specific service authorization information, viii) names of supported services, ix) endpoint information of instance(s) of each supported service, x) ID of stored data/information, and xi) other service parameters (e.g., DNN, notification endpoint for each type of notification that the NF service is interested in receiving).

In the context of network slicing, based on network implementation, multiple NRFs may be deployed at different levels:

i) PLMN level (the NRF is configured with information for the whole PLMN), ii) shared-slice level (the NRF is configured with information belonging to a set of network slices), and iii) slice-specific level (the NRF is configured with information belonging to an S-NSSAI).

In the context of roaming, multiple NRFs may be deployed in the different networks:

i) NRF(s) in a visited PLMN (known as vNRF) configured with information for the visited PLMN, and ii) NRF(s) in a home PLMN (known as the hNRF) configured with information for the home PLMN, referenced by the vNRF via an N2 7 interface,

<Network Function and Network Function Service Registration and Deregistration)>

For the NRF to properly maintain information of available NF instances and their supported services, each NF instance informs the NRF of a list of NF services that it supports.

The NF instance may make this information available to an NRF when the NF instance becomes operative for the first time (registration operation) or upon individual NF service instance activation/de-activation within the NF instance (update operation). The NF instance while registering the list of NF services it supports, for each NF service, may provide notification endpoint information for each type of notification service that the NF service is prepared to consume, to the NRF during the NF instance registration. The NF instance may also update or delete NF service related parameters (e.g., to delete the notification endpoint information). Alternatively, another authorized entity (such as an OA&M function) may inform the NRF on behalf of an NF instance triggered by an NF service instance lifecycle event (register or de-registration operation depending on instance instantiation, termination, activation, or de-activation). Registration with the NRF includes capacity and configuration information at time of instantiation.

The NF instance may also de-register from the NRF when the NF instance is about to gracefully shut down or disconnect from the network in a controlled way.

If an NF instance become unavailable or unreachable due to unplanned errors (e.g., NF crashes or network issues), an authorized entity may deregister the NF instance with the NRF.

<Management Support for NRF>

1. Goal

The operator may maintain, to an up-to-date state, discovery information (e.g., NF ID, IP address) of a 5GC NF instances in an NRF instance that is used for NF instance and service discovery.

2. Pre-Conditions

The NRF instance storing the discovery information for the available 5GC NF is deployed.

3. Steps

i) When a new 5GC NF instance is deployed, a 3GPP management system or a new 5GC NF instance needs to make the NRF instance aware of the discovery information (e.g. NF ID, IP address) of the new 5GC NF instance.

ii) When discovery information of a 5GC NF instance is changed, the 3GPP management system or the 5GC NF instance needs to update the 5GC NF discovery information maintained by the NRF instance.

iii) When the 5GC NF instance is removed, the 3GPP management system needs to make the NRF instance aware that the 5GC NF is removed.

<5GC Management Requirements>

REQ-5GCN-CON-1: The 3GPP management system may be able to support configuration management (e.g., CRUD MOI) on the 5GC NF/NE.

REQ-5GCN-CON-2: The 3GPP management system may be able to collect performance data from the 5GC NF/NE.

REQ-5GCN-CON-3: The 3GPP management system may be able to support fault management on the 5GC NF/NE.

REQ-5GCN-CON-4: The 3GPP management system may reflect a service based architecture characteristic in the NRM of 5GC CP NF/NE.

REQ-5GCN-CON-5: The 3GPP management system may be able to establish a relationship between DSF and associated 5GC NFs.

REQ-5GCN-CON-6: The 3GPP management system may be able to support coordination between lifecycle management operations on associated 5GC NFs and lifecycle management operations on DSF.

REQ-5GCN-CON-7: The 3GPP management system or the 5GC NF instance may be able to register/de-register with the NRF instance discovery information of the 5GC NF instance.

REQ-5GCN-CON-8: The 3GPP management system may be able to support configuration management of AMF set.

REQ-5GCN-CON-9: The 3GPP management system may be able to support AMF set related performance management, such as AMF set performance reporting or alarm.

The systems and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include a plurality of processing elements and a plurality of types of processing elements. For example, a processing device may include a plurality of processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of managing a network function (NF) profile, the method comprising:
receiving, by a network function repository function (NRF), a registration request from a management system in response to deploying of a new NF instance;
adding, by the NRF, an NF profile of the new NF instance in response to the registration request; and
sending, by the NRF, a registration response to the management system.

2. The method of claim 1, wherein the NRF comprises NF instance information, and
the NF profile of the NF instance is maintained to an up-to-date state.

3. The method of claim 1, wherein the NF profile comprises at least one of an NF instance ID, an NF type, a fully qualified domain name (FQDN) or an Internet protocol (IP) address of an NF, a public land mobile network (PLMN) ID, a network slice related identifier, NF capacity information, NF specific service authorization information, identification of stored information, names of supported services, and endpoint information of instance of each supported service.

4. The method of claim 3, wherein the network slice related identifier comprises network slice selection assistance information (NSSAI), single-network slice selection assistance information (S-NSSAI), and network slice instance (NSI) ID.

5. A method of managing a network function (NF) profile, the method comprising:
receiving, by a network function repository function (NRF), an update request from a management system in response to a change of an NF profile of an NF instance;
updating, by the NRF, the NF profile of the NF instance in response to the update request; and
sending, by the NRF, an update response to the management system.

6. The method of claim 5, wherein the NRF comprises NF instance information, and
the NF profile of the NF instance is maintained to an up-to-date state.

7. The method of claim 5, wherein the NF profile comprises at least one of an NF instance ID, an NF type, a fully qualified domain name (FQDN) or an Internet protocol (IP) address of an NF, a public land mobile network (PLMN) ID, a network slice related identifier, NF capacity information, NF specific service authorization information, identification of stored information, names of supported services, and endpoint information of instance of each supported service.

8. The method of claim 7, wherein the network slice related identifier comprises network slice selection assistance information (NSSAI), single-network slice selection assistance information (S-NSSAI), and network slice instance (NSI) ID.

9. A method of managing a network function (NF) profile, the method comprising:
receiving, by a network function repository function (NRF), a deregistration request from a management system in response to removal of an NF instance;
deleting, by the NRF, an NF profile of the NF instance in response to the deregistration request; and
sending, by the NRF, a deregistration response to the management system.

10. The method of claim 9, wherein the NRF comprises NF instance information, and
the NF profile of the NF instance is maintained to an up-to-date state.

11. The method of claim 9, wherein the NF profile comprises at least one of an NF instance ID, an NF type, a fully qualified domain name (FQDN) or an Internet protocol (IP) address of an NF, a public land mobile network (PLMN) ID, a network slice related identifier, NF capacity information, NF specific service authorization information, identification of stored information, names of supported services, and endpoint information of instance of each supported service.

12. The method of claim 11, wherein the network slice related identifier comprises network slice selection assistance information (NSSAI), single-network slice selection assistance information (S-NSSAI), and network slice instance (NSI) ID.
